(19) United States
(12) Patent Application Publication
(10) Pub. No.: US 2010/0191423 A1
(43) Pub. Date: Jul. 29, 2010

(54) VEHICLE ROLLOVER PREVENTION CONTROL APPARATUS AND VEHICLE ROLLOVER PREVENTION CONTROL METHOD

(75) Inventors: Kotaro KOYAMA, Isehara-shi (JP); Motohiro Higuma, Atsugi-shi (JP)

Correspondence Address: FOLEY AND LARDNER LLP;SUITE 500, 3000 K STREET NW, WASHINGTON, DC, 20007, US

(73) Assignee: HITACHI AUTOMOTIVE SYSTEMS, LTD.

(21) Appl. No.: 12/648,947

(22) Filed: Dec. 29, 2009

(30) Foreign Application Priority Data
Jan. 23, 2009 (JP) 2009-013254

(51) Int. Cl. B60W 30/04; B60W 10/18; B60W 10/20; B60W 10/22

(52) U.S. Cl. 701/42

(57) ABSTRACT

In a vehicle rollover prevention control apparatus employing a brake system serving as an actuator configured to control a dynamic behavior of a vehicle, a steering-input decision section is provided to make a rollover prediction, based on a driver-applied steering input, whether a predetermined level of roll motion for the vehicle occurs, and also to detect a driver-applied steering-back action. Also provided is an active rollover prevention control intervention decision section configured to make a rollover decision about rollover of the vehicle when the driver-applied steering-back action has been detected. An active rollover prevention control section is configured to execute rollover prevention control by controlling the actuator, when it is predicted for the predetermined level of roll motion to occur by the steering-input decision section and the rollover decision that rollover will occur has been made by the active rollover prevention control section.

### TECHNICAL FIELD

The present invention relates to a vehicle rollover prevention control apparatus and a vehicle rollover prevention control method, and specifically to the improvement of an active rollover prevention control technology for actively preventing “rollover” of an automotive vehicle.

### BACKGROUND ART

In recent years, there have been proposed and developed various active rollover prevention control technologies. One such active rollover prevention (ARP) control system has been disclosed in Japanese Patent Provisional Publication No. 2005-28918 (hereinafter is referred to as “JP2005-028918”). In the active rollover prevention control system of JP2005-028918, a risk of “rollover” of an automotive vehicle is judged or determined based on both a steering angle of a steering wheel and a steering angular velocity in a further steering direction, and the “rollover” is prevented by braking-force application to the outside wheels turning. In order to more precisely timely execute active rollover prevention (ARP) control, the further enhancement of the accuracy of a rollover decision would be desirable.

### SUMMARY OF THE INVENTION

Accordingly, it is an object of the invention to provide a vehicle rollover prevention control apparatus and a vehicle rollover prevention control method capable of more greatly enhancing the accuracy of a rollover decision.

In order to accomplish the aforementioned and other objects of the present invention, a vehicle rollover prevention control apparatus comprises an actuator configured to control a dynamic behavior of a vehicle, a rollover prediction section configured to make a rollover prediction, based on a driver-applied steering input, whether a predetermined level of roll motion for the vehicle occurs, a steering-back detection section configured to detect a driver-applied steering-back action, a rollover decision section configured to make a rollover decision about rollover of the vehicle when the driver-applied steering-back action has been detected, and a rollover prevention control section configured to execute rollover prevention control by controlling the actuator, when it is predicted for the predetermined level of roll motion to occur by the rollover prediction section and the rollover decision that rollover will occur has been made by the rollover decision section.

According to another aspect of the invention, a vehicle rollover prevention control apparatus comprises an actuator configured to control a dynamic behavior of a vehicle, a steering angular velocity detection section configured to detect a steering angular velocity during a driver-applied further steering action, a steering angle sensor configured to detect a steering angle, a yaw rate sensor configured to detect a yaw rate of the vehicle, an acceleration sensor configured to detect a lateral acceleration exerted on the vehicle, a rollover prediction section configured to make a prediction, based on at least a signal from the steering angular velocity detection section and a signal from the steering angle sensor, whether a predetermined level of roll motion for the vehicle occurs, a vehicle behavior detection section configured to detect the vehicle dynamic behavior based on information from at least the yaw rate sensor and the acceleration sensor, a rollover decision section configured to make a rollover decision about rollover of the vehicle when a driver-applied steering-back action has been detected for a period of time during which the vehicle behavior detection section determines that a specified vehicle behavior occurs, and a rollover prevention control section configured to execute rollover prevention control by controlling the actuator, when the rollover decision that rollover will occur has been made by the rollover decision section.

According to a further aspect of the invention, a vehicle rollover prevention control method comprises executing a rollover prediction, based on a steering angular velocity of a vehicle during a driver-applied further steering action, whether a high level of roll motion for the vehicle occurs, and executing rollover prevention control when a driver-applied steering-back action has been detected after the rollover prediction has been satisfied.

The other objects and features of this invention will become understood from the following description with reference to the accompanying drawings.

### BRIEF DESCRIPTION OF THE DRAWINGS

FIG. 1 is a system diagram illustrating an automotive vehicle to which an active rollover prevention (ARP) control apparatus of the embodiment can be applied.

FIG. 2 is a control block diagram related to ARP control executed within an electronic control unit (ECU) incorporated in the ARP control apparatus of the embodiment.

FIG. 3 is a flowchart illustrating a flow of an ARP control decision executed within the ECU of the apparatus of the embodiment.

FIG. 4 is a flowchart illustrating a flow of set/reset processing of a steering-input decision flag.

FIG. 5 is a time chart illustrating a steering angle signal in the presence of a steering input by which “rollover” can be predicted.

FIG. 6 is a flowchart illustrating a flow of the steering angle signal generation processing, related to step S103 of FIG. 4.

FIGS. 7A-7D are time charts illustrating a variation in steering angular velocity used for steering-input decision in the presence of a steering input by which “rollover” can be predicted (concretely, in the presence of a state transition of rightward steered road wheel movement→leftward steered road wheel movement→straight-ahead state).

FIGS. 8A-8D are time charts illustrating a variation in steering angular velocity used for steering-input decision in the presence of a steering input by which “rollover” can be predicted (concretely, in the presence of a state transition of leftward steered road wheel movement→rightward steered road wheel movement→straight-ahead state).

FIG. 9 is a flowchart illustrating a flow of calculation of the steering-input decision preliminary counter-1, related to step S104 of FIG. 4.

FIGS. 10A-10F are time charts illustrating a variation in steering state variable and a variation in counted value of the steering-input decision preliminary counter-1, in the presence of a steering input by which “rollover” can be predicted.

FIG. 11 is a flowchart illustrating a flow of calculation of the steering-input decision preliminary counter-2, related to step S105 of FIG. 4.

FIGS. 12A-12H are time charts illustrating a variation in steering state variable and a variation in counted value of the steering-input decision preliminary counter-2, in the presence of a steering input by which “rollover” can be predicted.

FIG. 13 is a flowchart illustrating a flow of the steering-input decision flag set processing, related to step S106 of FIG. 4.

FIGS. 14A-14I are time charts illustrating a variation in steering state variable and a variation in counted value of the steering-input decision preliminary counter-3, in the presence of a steering input by which “rollover” can be predicted.

FIG. 15 is a flowchart illustrating a flow of the steering-input decision flag reset processing, related to step S107 of FIG. 4.

FIGS. 16A-16G are time charts illustrating a variation in steering state variable and a variation in counted value of a steering-input decision flag reset counter, in the case that the vehicle has been transferred to a straight-ahead state after a steering input by which “rollover” can be predicted.

FIGS. 17A-17I are time charts illustrating a variation in steering state variable and a variation in counted value of the steering-input decision flag reset counter, in the case that the vehicle has been transferred to a vehicle-behavior stable state after a steering input by which “rollover” can be predicted.

FIG. 18 is a flowchart illustrating a flow of an ARP control execution decision, performed within the ECU of the apparatus of the embodiment.

FIG. 19 is a flowchart illustrating a flow of ARP vehicle-behavior unstable state decision processing.

FIGS. 20A-20F are time charts illustrating a variation in counted value of an ARP counter in the presence of a steering input by which “rollover” can be predicted.

FIG. 21 is a flowchart illustrating a target lateral acceleration calculation routine.

FIGS. 22A-22C are time charts illustrating a method to generate a target yaw rate signal and a method to calculate a maximum value of a finite difference between the target yaw rate signal value and an actual yaw rate signal value, in the ARP control system of the embodiment.

FIG. 23 is a target lateral acceleration gain table used in the ARP control system of the embodiment.

FIGS. 24A-24B are time charts illustrating a method to calculate a raw value (raw data) of the target lateral acceleration, in the ARP control system of the embodiment.

FIG. 25 is a flowchart illustrating a target deceleration calculation routine.

FIGS. 26A-26C are time charts illustrating an operating state of ARP control.

FIGS. 27A-27G are time charts illustrating a variation in target vehicle speed and a variation in target deceleration, during ARP control.

FIG. 28 is a flowchart illustrating a flow of ARP control intervention decision processing.

FIGS. 29A-29I are time charts illustrating a variation in ARP target fluid pressure and a variation in ARP control signal, during ARP control.

FIGS. 30A-30J are time charts illustrating rollover prevention control action performed by the ARP control system of the embodiment.

FIG. 31 is an explanatory drawing illustrating rollover prevention control action performed by the ARP control system of the embodiment.

### DESCRIPTION OF THE PREFERRED EMBODIMENTS

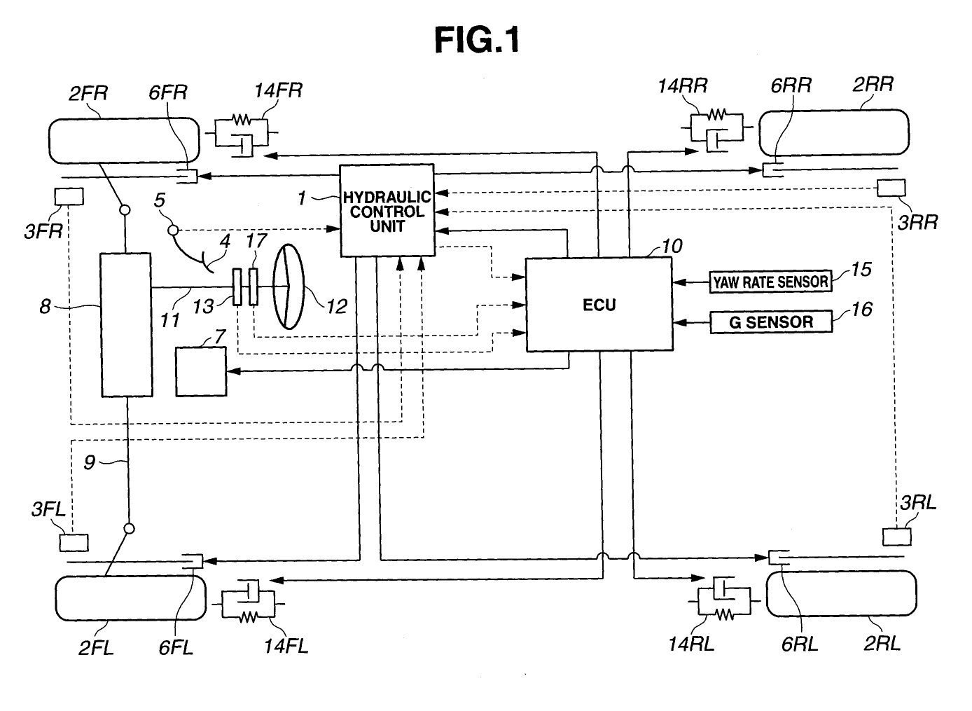

Referring now to the drawings, particularly to FIG. 1, the active rollover prevention (ARP) control apparatus of the embodiment is exemplified in a four-wheeled automotive vehicle employing four wheel brakes. The ARP control apparatus of the embodiment has been configured and investigated in such a manner as to be applicable to several needs. One of the needs is to more greatly enhance the accuracy of a rollover decision. Hereunder described in detail, the ARP control apparatus of the embodiment is also configured to meet the needs of suppressing unnecessary or wasteful intervention of ARP control. The ARP control apparatus of the embodiment is further configured to meet the other needs such as rapid stabilization of the vehicle dynamic behavior.

As seen from the system diagram of FIG. 1, the ARP control apparatus of the embodiment includes a hydraulic control unit 1 and an electronic control unit (ECU) 10. Hydraulic control unit 1 is configured to regulate or modulate wheel-brake cylinder pressures of disc brakes 6FL, 6FR, 6RL, and 6RR provided at respective road wheels 2FL, 2FR, 2RL, and 2RR, based on wheel speed signals VwFL, VwFR, VwRL, and VwRR from front-left, front-right, rear-left, and rear-right wheel-speed sensors 3FL, 3FR, 3RL, and 3RR, and a brake-pedal stroke signal from a brake-pedal stroke sensor 5. Four wheel-speed sensors 3FL-3RR are provided at respective road wheels 2FL-2RR, whereas brake-pedal stroke sensor 5 is provided at a brake pedal 4. In the shown embodiment, for instance, a hydraulic control unit (e.g., a hydraulic control module formed integral with a subordinate control unit), which can be applied to an anti-lock brake system (ABS), is used as the hydraulic control unit 1.

During execution of active rollover prevention (ARP) control (described later), hydraulic control unit 1 is configured to build up wheel-brake cylinder pressures of front-left and front-right road wheels 2FL-2FR responsively to a control command from ECU 10. Hydraulic control unit 1 and disc brakes 6FL-6RR construct a brake system configured to regulate or adjust the individual wheel-brake cylinder pressures (i.e., the braking forces applied to respective road wheels 2FL-2RR) independently of each other. As described hereinafter, the brake system serves as a vehicle-dynamics-control (VDC) actuator as well as an ARP control actuator.

An electronically-controlled power steering (EPS) motor 7 is provided to output a steering assistance force to a rack-shaft 9 of a steering mechanism 9 for assisting a driver's steering effort. The operation of EPS motor 7 is controlled by ECU 10. ECU 10 is configured to control the driving state of EPS motor 7, based on a steering torque signal from a steering torque sensor 13 and a vehicle speed (vehicle-body velocity) calculated by hydraulic control unit 1, during normal control.

EPS motor 7 is also configured to reduce a further-steering period steering assistance force produced during initial steering rollover prevention control (described later), responsively to a control command from ECU 10, as compared to the magnitude of a steering assistance force produced during the normal control. A steering wheel 12, a column shaft 11, steering mechanism 8, and EPS motor 7 construct a variable assistance force steering system configured to variably adjust a steering assistance force (a steering assistance torque).

Variable damping force electronically-controlled suspensions 14FL, 14FR, 14RL, and 14RR are also provided at the respective road wheels, for supporting the upper portion of the vehicle on its axles and road wheels 2FL, 2FR, 2RL, and 2RR. The magnitudes of damping forces of these electronically-controlled suspensions 14FL-14RR can be variably controlled by ECU 10, independently of each other. ECU 10 is configured to control the driving states of electronically-controlled suspensions 14FL-14RR, based on a yaw rate signal from a yaw rate sensor (a yaw rate detector) 15, and a vehicle acceleration signal (including both longitudinal acceleration and lateral acceleration) from an acceleration sensor (an accelerator detector) 16, during the normal control. For instance, during initial suspension rollover prevention control (described later), responsively to a control command from ECU 10, compression-side damping forces of the two electronically-controlled suspensions associated with the outside wheels turning can be varied (raised up) to higher damping forces, as compared to the magnitudes of the compression-side damping forces of the outside-wheel-suspensions produced during normal control.

As shown in FIG. 1, ECU 10 (a super-ordinate control unit capable of managing engine control as well as active rollover prevention control (described later) and vehicle dynamics control (described later)) generally comprises a microcomputer. ECU 10 includes an input/output interface (I/O), memories (RAM, ROM), and a microprocessor or a central processing unit (CPU). The input/output interface (I/O) of ECU 10 receives input information about the vehicle speed calculated by hydraulic control unit 1 as well as input information from various vehicle sensors, namely, steering torque sensor 13, yaw rate sensor 15, acceleration sensor 16, a steering angle sensor 17 (described later), and the like. For mutual communication via a data link, ECU 10 is electrically connected to hydraulic control unit 1, and thus the input interface of ECU 10 also receives wheel speed sensor signals VwFL-VwRR. Within ECU 10, the central processing unit (CPU) allows the access by the I/O interface of input informational data signal (vehicle-speed indicative data) from hydraulic control unit 1 as well as the sensor signals from the previously-discussed vehicle sensors. The CPU of ECU 10 is responsible for carrying the control programs stored in memories and is capable of performing necessary arithmetic and logic operations (described later by reference to the flowcharts). Computational results (arithmetic calculation results), that is, calculated output signals are relayed through the output interface circuitry of ECU 10 to output stages, namely control actuators (concretely, hydraulic control unit 1, electronically-controlled suspensions 14FL-14RR, and EPS motor 7). ECU 10 is configured to execute active rollover prevention (ARP) control, based on the vehicle sensor signals and the vehicle speed (calculated by hydraulic control unit 1), so as to prevent “rollover” from occurring by suppressing an increase in lateral acceleration that would develop in the presence of a driver's quick steering action to avoid a potential collision with a frontal obstacle. Furthermore, ECU 10 is configured to execute initial suspension rollover prevention control for suppression of the vehicle roll angle and initial steering rollover prevention control for suppression of the amount (the degree) of further steering, prior to ARP control.

Also, ECU 10 is configured to execute vehicle dynamics control (VDC) independently of the previously-noted active rollover prevention (ARP) control, so as to suppress oversteer or understeer tendencies of the vehicle. When the VDC mode is activated, the processor of ECU 10 calculates a target sideslip amount (a target sideslip angle), based on input information about a steering angle of steering wheel (detected by steering angle sensor 17), and a brake pedal stroke (detected by brake pedal stroke sensor 5). The processor of ECU 10 also calculates a sideslip amount (an actual sideslip angle), based on input information about a yaw rate (detected by yaw rate sensor 15), a lateral acceleration (detected by acceleration sensor 16), and respective wheel speeds VwFL-VwRR (detected by wheel speed sensors 3FL-3RR). Then, the processor of ECU 10 calculates a deviation between the calculated target sideslip amount and the calculated sideslip amount. ECU 10 outputs a drive signal, determined based on the calculated sideslip deviation, to hydraulic control unit 1, to independently control (build up, reduce, or hold) the respective wheel-brake cylinder pressures. In this manner, during execution of the VDC mode, the vehicle's yawing moment can be controlled. Hence, the vehicle can be approached closer to a line of travel intended by the driver, and therefore the driving stability can be enhanced by virtue of vehicle dynamics control. Switching between an enabled (ON) state and a disabled (OFF) state (i.e., an inhibition state) of the VDC system can be attained by means of a man-machine interface (e.g., a VDC function enabling/disabling switch).

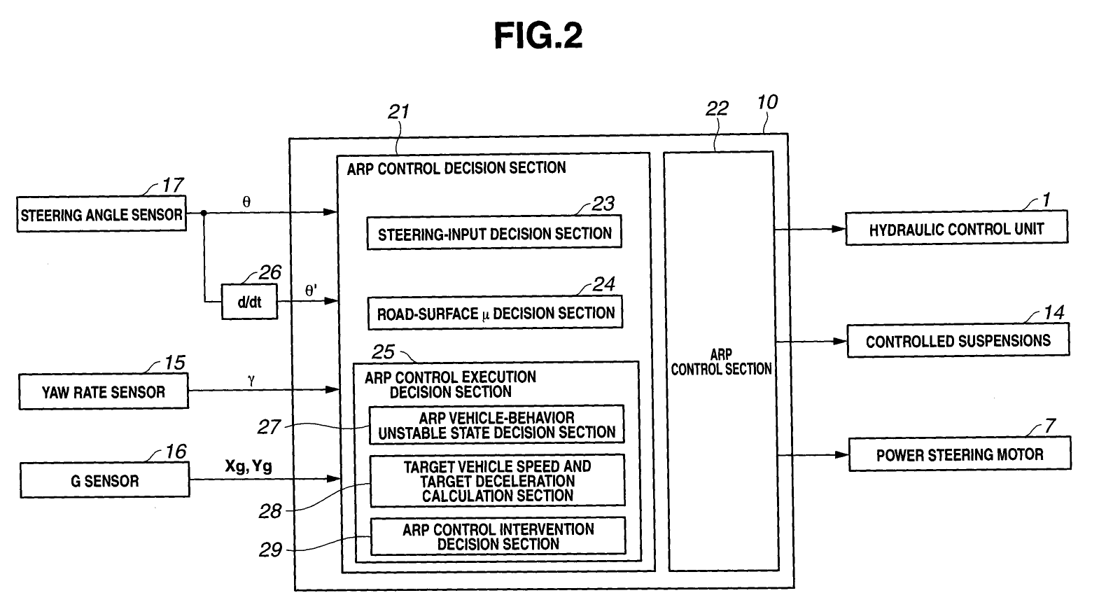

Referring now to FIG. 2, there is shown the block diagram related to active rollover prevention (ARP) control executed by ECU 10 incorporated in vehicle rollover prevention control apparatus of the embodiment. As seen from the block diagram of FIG. 2, ECU 10 is mainly comprised of an ARP control decision section 21 and an ARP control section (a vehicle rollover prevention control section) 22. ARP control decision section 21 is configured to determine, based on input information from the vehicle sensors (i.e., yaw rate sensor 15, acceleration sensor 16, and steering angle sensor 17), whether the ARP control function is engaged (enabled) or disengaged (disabled). ARP control section 22 is configured to control the driving state of each of hydraulic control unit 1, variable damping force electronically-controlled suspensions 14FL-14RR, and EPS motor 7, responsively to the decision result of ARP control decision section 21.

ARP control decision section 21 includes a steering-input decision section (a rollover prediction section, a steering-back detection section) 23, a road-surface μ decision section (a road-surface friction coefficient calculation section) 24, and an ARP control execution decision section (an ARP control enabled/disabled decision section) 25.

Steering-input decision section 23 is configured to make a steering-input decision, based on input information about (i) a steering angle signal θ from steering angle sensor (steering angle detector) 17 and (ii) a steering angular velocity signal dθ/dt from a differentiator 26 (serving as a steering angular velocity detector). The steering angular velocity signal value is arithmetically obtained as the first-order derivative dθ/dt of the steering angle signal θ from steering angle sensor 17. Steering-input decision section 23 is further configured to generate a steering state variable based on the decided steering-input state. Hereupon, the driver-applied steering input is used as a measure of predictions of “rollover” of the vehicle. The driver-applied steering input, acting to roll over the vehicle, corresponds to such a steering input that steering wheel 12 is further steered by the driver, and thereafter steering wheel 12 is steered back, passing through a neutral position of steering wheel 12 (simply, the steering neutral position). The former driver-applied further steering action is called “primary avoidance steering” for collision avoidance (for road obstacle avoidance), whereas the latter driver-applied steering-back action is called “secondary avoidance steering” for collision avoidance (for road obstacle avoidance). Also, the former-half steering-back action from the beginning of steering-back action to the steering neutral position is called “primary steering-back”, whereas the latter-half steering-back action from the steering neutral position to the end of steering-back action is called “secondary steering-back”.

Road-surface μ decision section 24 is configured to calculate a road-surface μ estimated value (an estimate of the road-surface friction coefficient), based on a longitudinal acceleration signal and a lateral acceleration signal, both generated from acceleration sensor 16. Assuming that the road-surface μ estimated value is denoted by “RM”, the detected longitudinal acceleration is denoted by “Xg”, and the detected lateral acceleration is denoted by “Yg”, road-surface p estimated value RM can be calculated or derived from the following expression.

RM=(Xg²+Yg²)^{1/2}

As set forth above, the road-surface μ can be estimated based on both longitudinal acceleration Xg and lateral acceleration Yg, but the other road-surface μ estimating method may be utilized.

ARP control execution decision section 25 is configured to carry out ARP control execution decision processing, so as to determine, based on the decision result of steering-input decision section 23, road-surface μ estimated value RM, yaw rate signal γ from yaw rate sensor 15, and lateral acceleration signal Yg from acceleration sensor 16, whether or not ARP control should be executed, in more detail, whether the ARP control function should be enabled (activated) or disabled (deactivated). ARP control execution decision section 25 includes an ARP vehicle-behavior unstable state decision section (a vehicle behavior detection section) 27, a target vehicle speed and target deceleration calculation section 28, and an ARP control intervention decision section (a rollover decision section) 29.

ARP vehicle-behavior unstable state decision section 27 is configured to carry out ARP vehicle-behavior unstable state decision processing so as to determine, based on the yaw rate signal γ, lateral acceleration signal Yg, steering angle signal θ, and the steering state variable, whether or not the vehicle dynamic behavior is unstable.

Target vehicle speed and target deceleration calculation section 28 is configured to carry out target vehicle speed and target deceleration calculation processing so as to calculate both a target vehicle speed and a target deceleration of the vehicle, based on the yaw rate signal γ, a yaw rate signal determined based on steering angle signal θ, and the road-surface μ estimated value RM.

ARP control intervention decision section 29 is configured to make an ARP control intervention decision, based on the calculated target deceleration, the road-surface μ estimated value RM, and the steering state variable. ARP control intervention decision section 29 is further configured to calculate target fluid pressures of wheel-brake cylinders of disk brakes 6FL-6FR of front-left and front-right road wheels 2FL-2FR (that is, ARP target fluid pressure values), based on the calculated target deceleration.

ARP control section 22 is configured to carry out ARP control by outputting a control command to hydraulic control unit 1 in such a manner as to bring the actual fluid pressures of wheel-brake cylinders of disk brakes 6FL-6FR of front-left and front-right road wheels 2FL-2FR closer to the calculated target fluid pressures.

ARP control section 22 is further configured to execute initial suspension rollover prevention control prior to ARP control, when steering-input decision section 23 outputs a signal indicating the steering state variable=“1”, such that, during initial suspension rollover prevention control, compression-side damping forces of the two suspensions associated with the outside wheels turning can be varied (raised up) to higher damping forces, as compared to the magnitudes of the compression-side damping forces of the outside-wheel-suspensions produced during normal control.

ARP control section 22 is still further configured to execute initial steering rollover prevention control prior to ARP control, when ARP vehicle-behavior unstable state decision section 27 determines that the vehicle behavior is unstable, in other words, when an ARP counter (described later) has been set to an unstable state decision threshold value, such that, during initial steering rollover prevention control, a further-steering period steering assistance force can be reduced responsively to a control command outputted from ECU 10 to EPS motor 7, as compared to the magnitude of a steering assistance force produced during normal control.

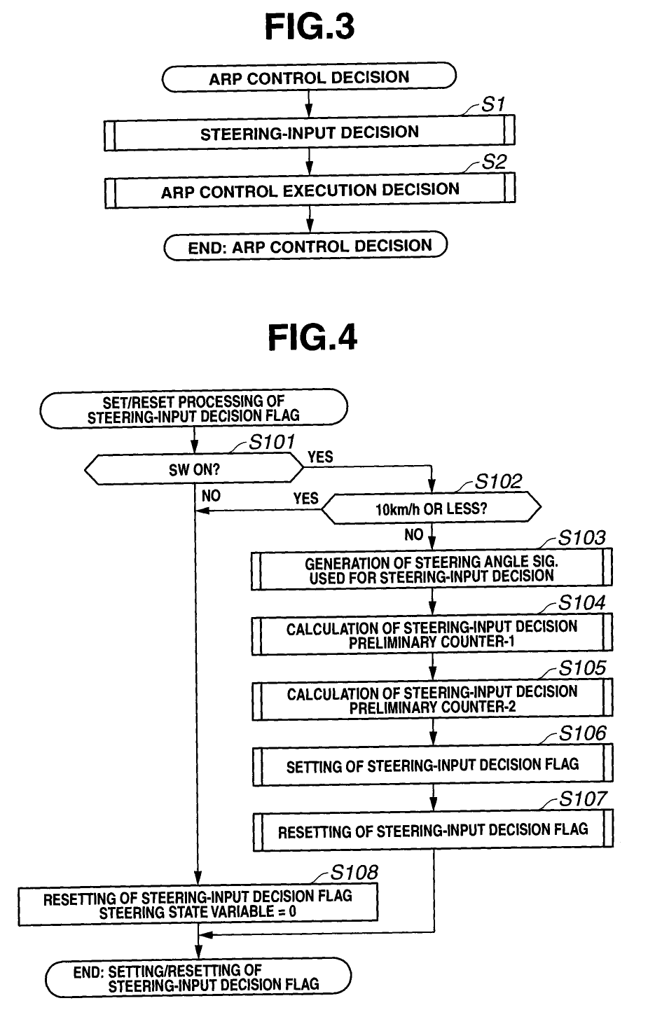

As can be seen from the flowchart of FIG. 3, within ARP control decision section 21, first, at step S1, the previously-discussed steering-input decision processing is made by means of steering-input decision section 23. At step S2, the previously-discussed ARP control execution decision processing is made by means of ARP control execution decision section 25.

Details of the steering-input decision processing and the ARP control execution decision processing are hereunder described.

### [Steering-Input Decision Processing]

### (Set/Reset Process of Steering-Input Decision Flag)

Referring now to FIG. 4, there is shown the flow of set/reset processing of a steering-input decision flag. The steering-input decision flag is used to determine whether a current steering input corresponds to a steering input by which “rollover” can be predicted.

At step S101, a check is made to determine whether an ARP control function enabling/disabling switch, simply, an ARP switch (not shown) is turned ON. When the answer to step S101 is in the affirmative (YES), that is, when the ARP switch is turned ON, the routine proceeds to step S102. Conversely the answer to step S101 is in the negative (NO), that is, when the ARP switch is turned OFF, the routine proceeds to step S108. The ARP switch is usually laid out within the manual arriving range of the driver, for instance, installed on steering wheel 12 or a vehicle instrument panel (e.g., an instrument panel cluster), such that turning ON/OFF of the ARP switch can be achieved by the driver during driving of the vehicle.

At step S102, a check is made to determine whether the vehicle speed is lower than or equal to a predetermined speed value such as 10 km/h. When the answer to step S102 is affirmative (YES), when vehicle speed ≦10 km/h, the routine proceeds to step S108. Conversely when the answer to step S102 is negative (NO), when vehicle speed >10 km/h, the routine proceeds to step S103.

At step S103, steering angle signal generation processing is executed to generate a steering angle signal used for steering-input decision. Thereafter, step S104 occurs.

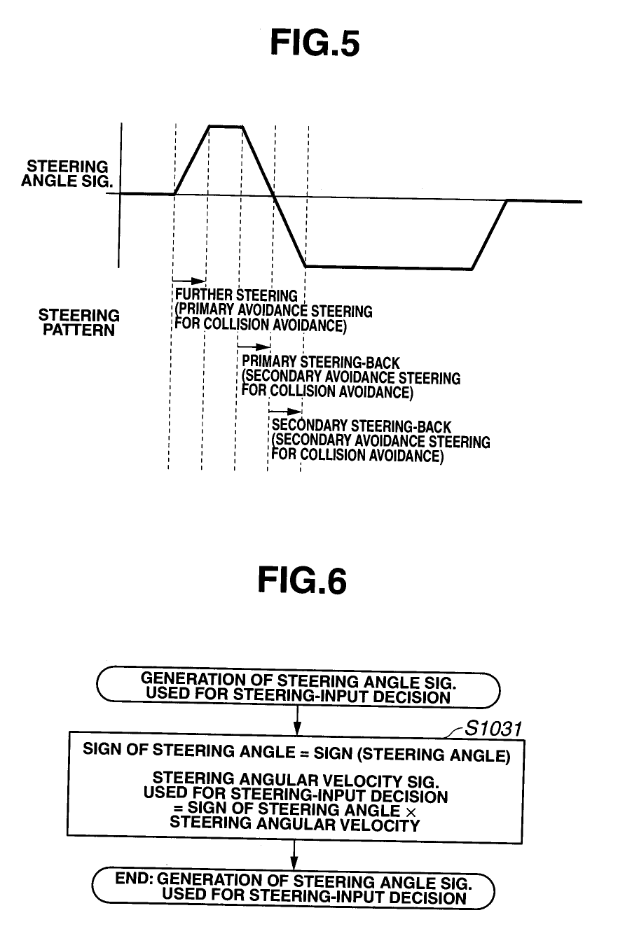

At step S104, a steering-input decision preliminary counter-1 (exactly, a counted value of the steering-input decision preliminary counter-1) is calculated. The steering-input decision preliminary counter-1 is configured to detect a further steering state as shown in FIG. 5. Thereafter, step S105 occurs.

At step S105, a steering-input decision preliminary counter-2 (exactly, a counted value of the steering-input decision preliminary counter-2) is calculated. The steering-input decision preliminary counter-2 is configured to detect a primary steering-back state as shown in FIG. 5. Thereafter, step S106 occurs.

At step S106, steering-input decision flag set processing is executed. The steering-input decision flag is used to detect a secondary steering-back state as shown in FIG. 5. Thereafter, step S107 occurs.

At step S107, steering-input decision flag reset processing is executed, and then one execution cycle of the steering-input decision flag set/reset processing terminates. When a vehicle straight-ahead state has been detected or when a vehicle-behavior stable state has been detected, the steering-input decision flag can be reset to “0”.

At step S108, the steering-input decision flag is reset, and at the same time the steering state variable is initialized to “0”, and then one execution cycle of the steering-input decision flag set/reset processing terminates.

### (Steering Angle Signal Generation Processing)

FIG. 6 shows the steering angle signal generation processing, executed through step S103 of FIG. 4. At step S1031 of FIG. 6, a sign of the steering angle and a steering angular velocity used for steering-input decision (simply, a steering-input decision steering angular velocity) are both calculated, and then one execution cycle of the steering angle signal generation processing terminates. Assuming that a rightward steered road wheel movement is indicated by a positive steering-angle sign, a leftward steered road wheel movement is indicated by a negative steering-angle sign, a steering angular velocity during rightward steered road wheel movement is indicated as a positive angular velocity, and a steering angular velocity during leftward steered road wheel movement is indicated as a negative angular velocity, the steering-input decision steering angular velocity signal is expressed as the product of the sign of the steering angle and the steering angular velocity.

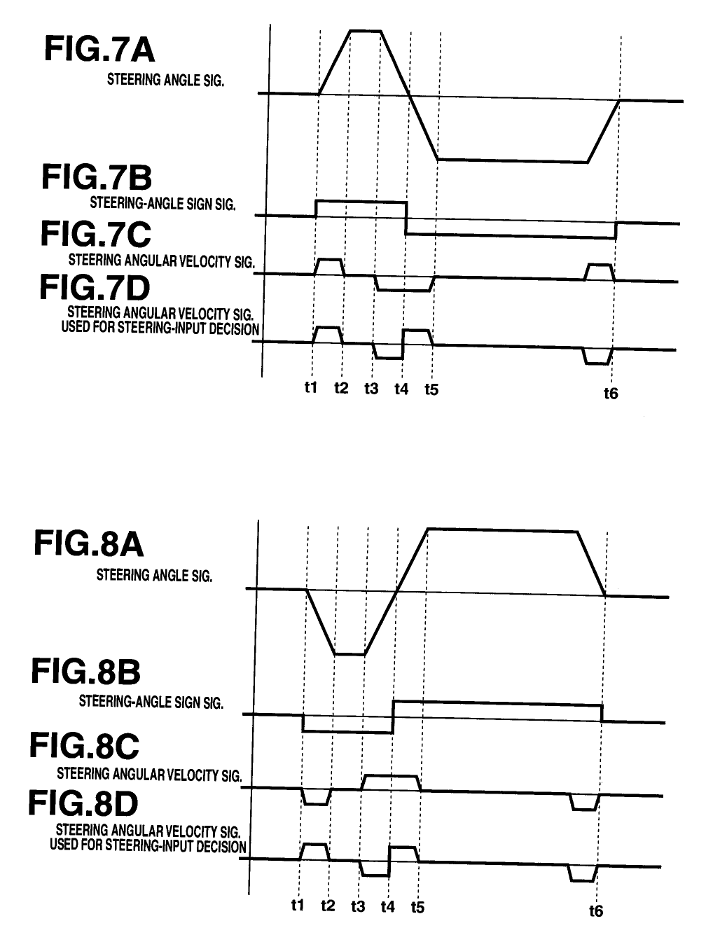

As seen from the time charts of FIGS. 7A-7D, in the presence of a state transition of rightward steered road wheel movement (or rightward angular displacement of steering wheel 12 from the straight-ahead position)→leftward steered road wheel movement (or leftward angular displacement of steering wheel 12 from the straight-ahead position)→straight ahead (corresponding to the straight-ahead position of steering wheel 12), the sign of the steering angle becomes positive during a time period t1-t4 from the time t1 to the time t4. The sign of the steering angle becomes negative after the point of time t4. On the other hand, the steering angular velocity becomes positive during a further steering period t1-t2 from the time t1 to the time t2. During a steering-kept period t2-t3 (with no angular displacement of steering wheel 12) from the time t2 to the time t3, the steering angular velocity becomes zero. Conversely during a steering-back period t3-t5 from the time t3 to the time t5, the steering angular velocity becomes negative. Therefore, the steering-input decision steering angular velocity becomes positive during the further steering period t1-t2. The steering-input decision steering angular velocity becomes zero during the steering-kept period t2-t3. The steering-input decision steering angular velocity becomes negative during the primary steering-back period t3-t4. The steering-input decision steering angular velocity becomes positive during the secondary steering-back period t4-t5.

As seen from the time charts of FIGS. 8A-8D, in the presence of a state transition of leftward steered road wheel movement (or leftward angular displacement of steering wheel 12 from the straight-ahead position)→rightward steered road wheel movement (or rightward angular displacement of steering wheel 12 from the straight-ahead position)→straight ahead (corresponding to the straight-ahead position of steering wheel 12), the sign of the steering angle becomes negative during the time period t1-t4 from the time t1 to the time t4. The sign of the steering angle becomes positive after the point of time t4. On the other hand, the steering angular velocity becomes negative during the further steering period t1-t2. The steering-input decision steering angular velocity becomes zero during the steering-kept period t2-t3. The steering-input decision steering angular velocity becomes positive during the steering-back period t3-t5. Hence, in the same manner as the presence of a state transition of rightward steered road wheel movement→leftward steered road wheel movement→straight ahead, in the presence of a state transition of leftward steered road wheel movement→rightward steered road wheel movement→straight ahead, the steering-input decision steering angular velocity becomes positive during the further steering period t1-t2. The steering-input decision steering angular velocity becomes zero during the steering-kept period t2-t3. The steering-input decision steering angular velocity becomes negative during the primary steering-back period t3-t4. The steering-input decision steering angular velocity becomes positive during the secondary steering-back period t4-t5. That is to say, regardless of the steering direction, the steering-input decision steering angular velocity tends to become positive during the further steering period, become zero during the steering-kept period, and become negative during the steering-back period.

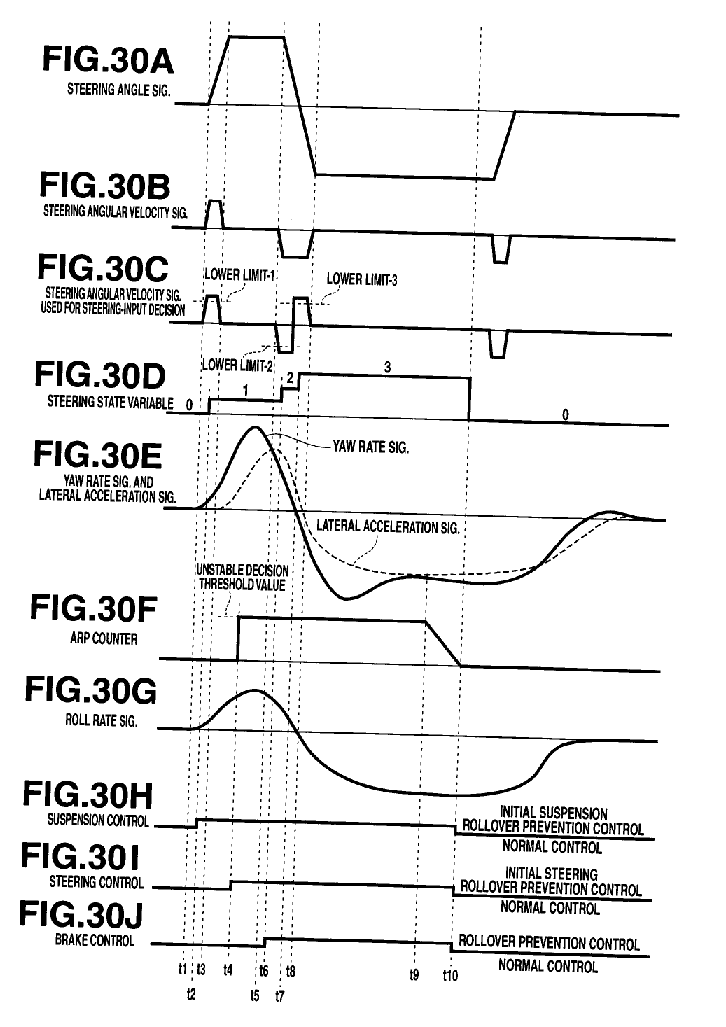

For the purpose of better understanding of the ARP control apparatus/method of the embodiment, a plurality of time charts are used. Notice that symbols (t1, t2, t3, . . . ) used in each of the time charts are applied to indicate different points of time for the same time chart group (e.g., FIGS. 7A-7D), but there is no relevancy between the point of time denoted by a certain symbol (e.g., “t1”) in one (e.g., FIGS. 7A-7D) of the plural time chart groups and the point of time denoted by the same symbol (e.g., “t1”) in the other time chart group (e.g., FIGS. 8A-8B, FIGS. 10A-10F, FIGS. 12A-12H, FIGS. 14A-14I, FIGS. 16A-16G, FIGS. 17A-17I, FIGS. 20A-20F, FIGS. 26A-26C, or FIGS. 30A-30J). For instance, the point of time denoted by the symbol “t2” in the time chart group of FIGS. 7A-7D differs from the point of time denoted by the same symbol “t2” in the time chart group of FIGS. 10A-10F.

### (Steering-Input Decision Preliminary Counter-1 Calculation Processing)

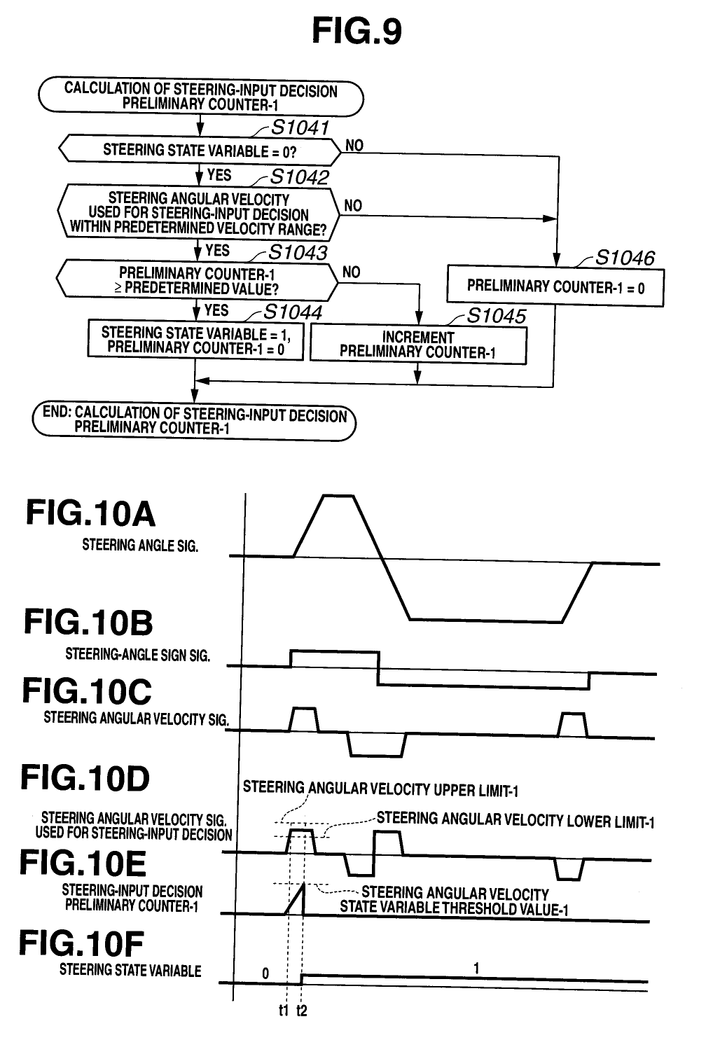

FIG. 9 shows the steering-input decision preliminary counter-1 calculation processing, executed through step S104 of FIG. 4.

At step S1041 of FIG. 9, a check is made to determine whether the steering state variable is reset to “0”. When the answer to step S1041 is affirmative (YES), the routine proceeds to step S1042. Conversely when the answer to step S1041 is negative (NO), the routine proceeds to step S1046.

At step S1042, a check is made to determine whether the steering-input decision steering angular velocity is within a predetermined angular velocity range from a steering-input decision steering angular velocity lower limit-1 to a steering-input decision steering angular velocity upper limit-1. When the answer to step S1042 is affirmative (YES), the routine proceeds to step S1043. Conversely when the answer to step S1042 is negative (NO), the routine proceeds to step S1046. The steering-input decision steering angular velocity lower limit-1 is set to such a steering angular velocity that can be regarded as a further steering action corresponding to primary avoidance steering for collision avoidance. On the other hand, the steering-input decision steering angular velocity upper limit-1 is set to an upper limit of steering angular velocities that can actually take place.

At step S1043, a check is made to determine whether the counted value of the steering-input decision preliminary counter-1 is greater than or equal to a predetermined value, exactly, a steering angular velocity state variable threshold value-1 used for steering-input decision (simply, a steering-input decision steering angular velocity state variable threshold value-1). When the answer to step S1043 is affirmative (YES), the routine proceeds to step S1044. Conversely when the answer to step S1043 is negative (NO), the routine proceeds to step S1045. The steering-input decision steering angular velocity state variable threshold value-1 is set to such a time length that can be regarded as a further steering action corresponding to primary avoidance steering for collision avoidance.

At step S1044, the steering state variable is set to “1”, and at the same time the steering-input decision preliminary counter-1 is cleared to “0”, and then one execution cycle of the routine terminates.

At step S1045, the steering-input decision preliminary counter-1 is incremented, and then one execution cycle of the routine terminates.

At step S1046, the steering-input decision preliminary counter-1 is cleared to “0”, and then one execution cycle of the routine terminates.

As seen from the time charts of FIGS. 10A-10F, illustrating a variation in steering state variable and a variation in counted value of the steering-input decision preliminary counter-1, in the presence of a steering input by which “rollover” can be predicted, at a point of time ti the steering-input decision steering angular velocity becomes higher than or equal to the steering-input decision steering angular velocity lower limit-1. Hence, at the time t1, a count-up operation of the steering-input decision preliminary counter-1 starts. At a point of time t2, the steering-input decision preliminary counter-1 becomes greater than or equal to the steering-input decision steering angular velocity state variable threshold value-1. Thus, at the time t2, the steering state variable is set to “1”, and the steering-input decision preliminary counter-1 is cleared to “0”.

### (Steering-Input Decision Preliminary Counter-2 Calculation Processing)

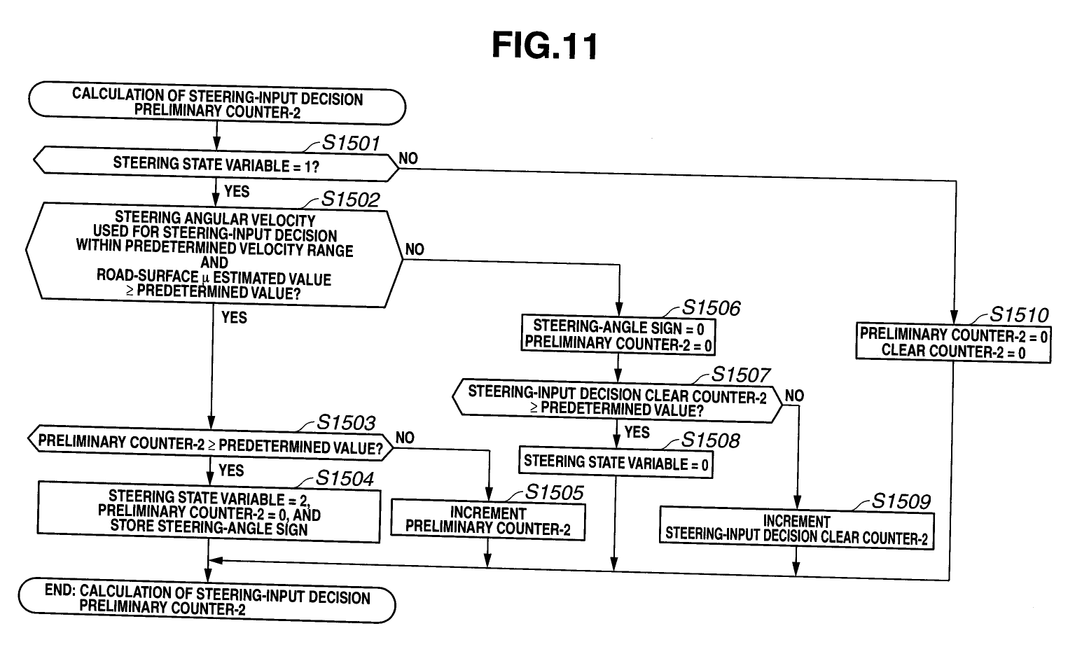

FIG. 11 shows the steering-input decision preliminary counter-2 calculation processing, executed through step S105 of FIG. 4.

At step S1501 of FIG. 11, a check is made to determine whether the steering state variable is set to “1”. When the answer to step S1501 is affirmative (YES), the routine proceeds to step S1502. Conversely when the answer to step S1501 is negative (NO), the routine proceeds to step S1510.

At step S1502, a check is made to determine whether the steering-input decision steering angular velocity is within a predetermined angular velocity range from a steering-input decision steering angular velocity lower limit-2 to a steering-input decision steering angular velocity upper limit-2, and the road-surface μ estimated value RM is greater than or equal to a predetermined value, exactly, a road-surface μ threshold value used for steering-input decision (simply, a steering-input decision road-surface μ threshold value). When the answer to step S1502 is affirmative (YES), the routine proceeds to step S1503. Conversely when the answer to step S1502 is negative (NO), the routine proceeds to step S1506. The steering-input decision steering angular velocity lower limit-2 is set to such a steering angular velocity that can be regarded as a steering-back action corresponding to secondary avoidance steering for collision avoidance. On the other hand, the steering-input decision steering angular velocity upper limit-2 is set to an upper limit of steering angular velocities that can actually take place. The steering-input decision road-surface μ threshold value is set to a road-surface friction coefficient corresponding to a high-μ road surface, such as dry pavements, having a high friction coefficient.

At step S1503, a check is made to determine whether the counted value of the steering-input decision preliminary counter-2 is greater than or equal to a predetermined value, exactly, a steering-input decision steering angular velocity state variable threshold value-2. When the answer to step S1503 is affirmative (YES), the routine proceeds to step S1504. Conversely when the answer to step S1503 is negative (NO), the routine proceeds to step S1505. The steering-input decision steering angular velocity state variable threshold value-2 is set to such a time length that can be regarded as a primary steering-back action corresponding to secondary avoidance steering for collision avoidance. To balance two contradictory requirements, namely, rapid detection of the primary steering-back action and avoidance of an erroneous decision of the primary steering-back action, the steering-input decision steering angular velocity state variable threshold value-2 is set to an appropriate time length experimentally assured by the inventors.

At step S1504, the steering state variable is set to “2”, the steering-input decision preliminary counter-2 is cleared to “0”, and at the same time the sign of the steering angle is stored, and then one execution cycle of the routine terminates.

At step S1505, the steering-input decision preliminary counter-2 is incremented, and then one execution cycle of the routine terminates.

At step S1506, the sign of the steering angle is set to “0”, and the steering-input decision preliminary counter-2 is cleared to “0”, and then one execution cycle of the routine terminates.

At step S1507, a check is made to determine whether the counted value of a steering-input decision clear counter-2 is greater than or equal to a predetermined value, exactly, a steering-input decision clear condition threshold value-2. When the answer to step S1507 is affirmative (YES), the routine proceeds to step S1508. Conversely when the answer to step S1507 is negative (NO), the routine proceeds to step S1509. The steering-input decision clear condition threshold value-2 is set to a standby time from the time when the driver-applied further steering action has been detected to the time when the driver-applied primary steering-back action has been detected.

At step S1508, the steering state variable is initialized to “0”, and then one execution cycle of the routine terminates. That is to say, assuming that there is no detection of primary steering-back action within the standby time (i.e., the steering-input decision clear condition threshold value-2) after the driver-applied further steering action has been detected, the processor of ECU 10 determines that there is no occurrence of a steering input by which “rollover” can be predicted. Thus, to avoid an erroneous decision, the steering state variable is initialized to “0”.

At step S1509, the steering-input decision clear counter-2 is incremented, and then one execution cycle of the routine terminates.

At step S1510, the steering-input decision preliminary counter-2 is cleared to “0” and at the same time the steering-input decision clear counter-2 is cleared to “0”, and then one execution cycle of the routine terminates.

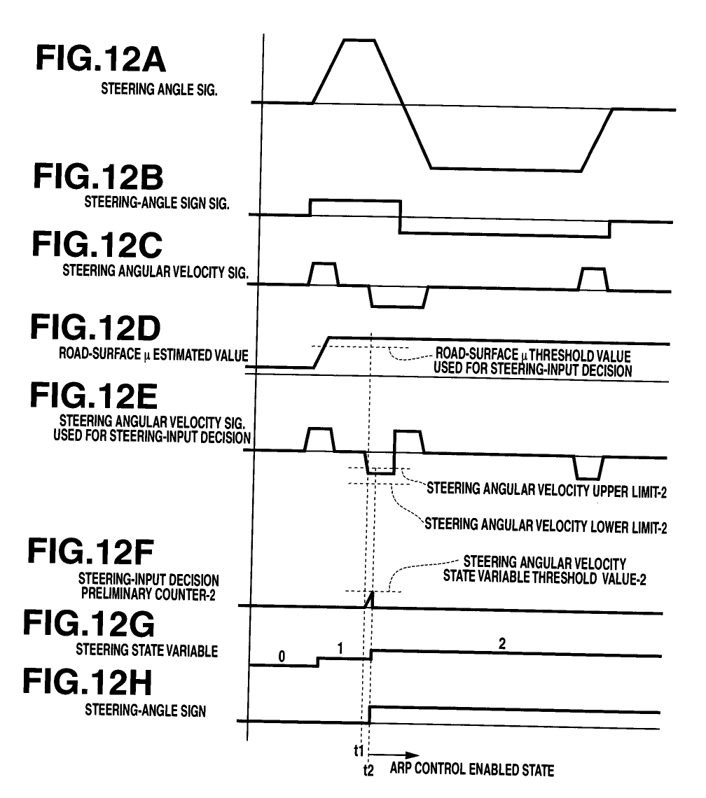

As seen from the time charts of FIGS. 12A-12H, illustrating a variation in steering state variable and a variation in counted value of the steering-input decision preliminary counter-2, in the presence of a steering input by which “rollover” can be predicted, at a point of time t1 the steering-input decision steering angular velocity becomes lower than or equal to the steering-input decision steering angular velocity upper limit-2 and the road-surface μ estimated value becomes greater than or equal to the steering-input decision road-surface μ threshold value. Hence, at the time t1, a count-up operation of the steering-input decision preliminary counter-2 starts. At a point of time t2, the steering-input decision preliminary counter-2 becomes greater than or equal to the steering-input decision steering angular velocity state variable threshold value-2. Thus, at the time t2, the steering state variable is set to “2”, and the steering-input decision preliminary counter-2 is cleared to “0”.

### (Steering-Input Decision Flag Set Processing)

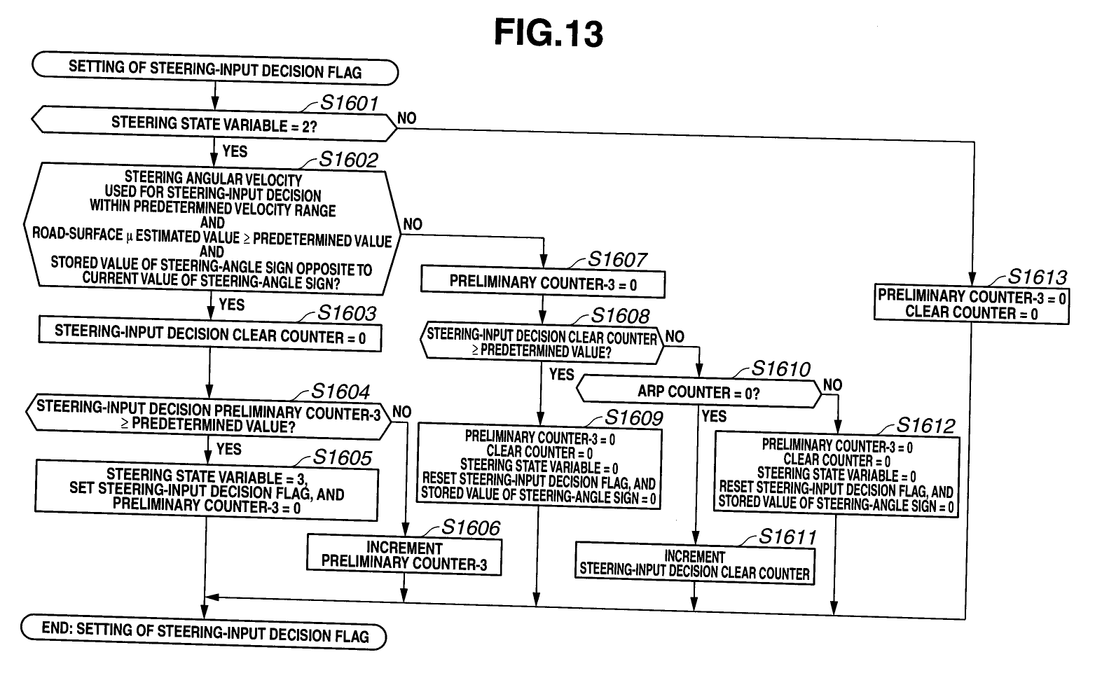

FIG. 13 shows the steering-input decision flag set processing, executed through step S106 of FIG. 4.

At step S1601, a check is made to determine whether the steering state variable is set to “2”. When the answer to step S1601 is affirmative (YES), the routine proceeds to step S1602. Conversely when the answer to step S1601 is negative (NO), the routine proceeds to step S1613.

At step S1602, a check is made to determine whether the steering-input decision steering angular velocity is within a predetermined angular velocity range from a steering-input decision steering angular velocity lower limit-3 to a steering-input decision steering angular velocity upper limit-3, and the road-surface μ estimated value is greater than or equal to the predetermined value (i.e., the steering-input decision road-surface μ threshold value), and the stored value of the steering-angle sign is opposite to the current value of the steering-angle sign. When the answer to step S1602 is affirmative (YES), the routine proceeds to step S1603. Conversely when the answer to step S1602 is negative (NO), the routine proceeds to step S1607. The steering-input decision steering angular velocity lower limit-3 is set to such a steering angular velocity that can be regarded as a steering-back action corresponding to secondary avoidance steering for collision avoidance. On the other hand, the steering-input decision steering angular velocity upper limit-3 is set to an upper limit of steering angular velocities that can actually take place. The steering-input decision road-surface μ threshold value is set to a road-surface friction coefficient corresponding to a high-μ road surface, such as dry pavements, having a high friction coefficient.

At step S1603, a steering-input decision clear counter is cleared to “0”. Thereafter, step S1604 occurs.

At step S1604, a check is made to determine whether a steering-input decision preliminary counter-3 is greater than or equal to a predetermined value, exactly, a steering-input decision steering angular velocity state variable threshold value-3. When the answer to step S1604 is affirmative (YES), the routine proceeds to step S1605. Conversely when the answer to step S1604 is negative (NO), the routine proceeds to step S1606. The steering-input decision steering angular velocity state variable threshold value-3 is set to such a time length that can be regarded as a secondary steering-back action corresponding to secondary avoidance steering for collision avoidance.

At step S1605, the steering state variable is set to “3”, the steering-input decision flag is set to “1”, and at the same time the steering-input decision preliminary counter-3 is cleared to “0”, and then one execution cycle of the routine terminates.

At step S1606, the steering-input decision preliminary counter-3 is incremented, and then one execution cycle of the routine terminates.

At step S1607, the steering-input decision preliminary counter-3 is cleared to “0”. Thereafter, the routine proceeds to step S1608.

At step S1608, a check is made to determine whether the counted value of the steering-input decision clear counter is greater than or equal to a predetermined value, exactly, a steering-input decision clear condition threshold value-3. When the answer to step S1608 is affirmative (YES), the routine proceeds to step S1609. Conversely when the answer to step S1608 is negative (NO), the routine proceeds to step S1610. The steering-input decision clear condition threshold value-3 is set to a standby time from the time when the driver-applied primary steering-back action has been detected to the time when the driver-applied secondary steering-back action has been detected.

At step S1609, the steering-input decision preliminary counter-3 is cleared to “0”, the steering-input decision clear counter is cleared to “0”, the steering state variable is initialized to “0”, the steering-input decision flag is reset to “0”, and the stored value of the steering-angle sign is cleared to “0”, and then one execution cycle of the routine terminates. That is to say, assuming that there is no detection of secondary steering-back action within the standby time (i.e., the steering-input decision clear condition threshold value-3) after the driver-applied primary steering-back action has been detected, the processor of ECU 10 determines that there is no occurrence of a steering input by which “rollover” can be predicted. Thus, to avoid an erroneous decision, the steering state variable is initialized to “0”.

At step S1610, a check is made to determine whether an ARP counter is cleared to “0”. When the answer to step S1610 is affirmative (YES), the routine proceeds to step S1611. Conversely when the answer to step S1610 is negative (NO), the routine proceeds to step S1612.

At step S1611, the steering-input decision clear counter is incremented, and then one execution cycle of the routine terminates.

At step S1612, the steering-input decision preliminary counter-3 is cleared to “0”, the steering-input decision clear counter is cleared to “0”, the steering state variable is initialized to “0”, the steering-input decision flag is reset to “0”, and the stored value of the steering-angle sign is cleared to “0”, and then one execution cycle of the routine terminates.

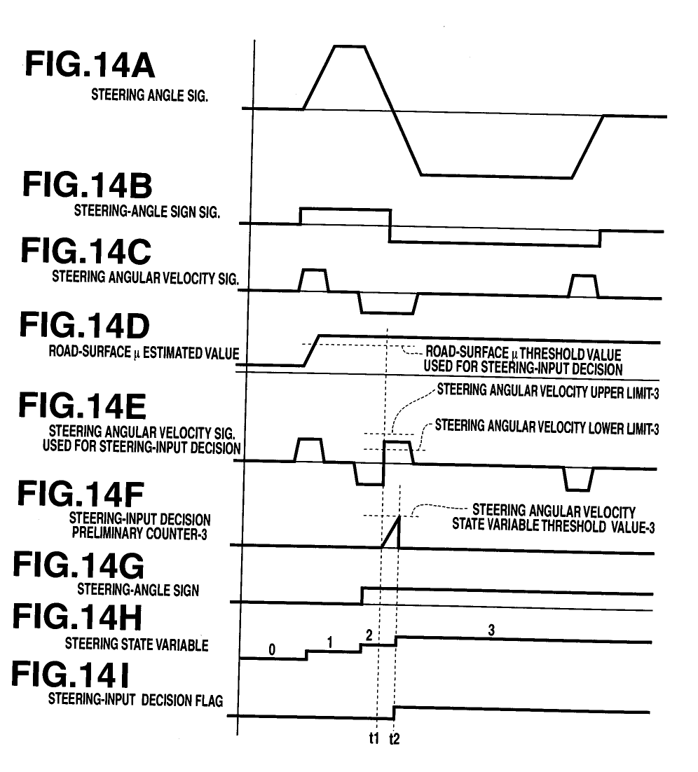

As seen from the time charts of FIGS. 14A-14I, illustrating a variation in steering state variable and a variation in counted value of the steering-input decision preliminary counter-3, in the presence of a steering input by which “rollover” can be predicted, at a point of time t1 the steering-input decision steering angular velocity becomes higher than or equal to the steering-input decision steering angular velocity lower limit-3, and the road-surface μ estimated value becomes greater than or equal to the steering-input decision road-surface μ threshold value, and the stored value (that is, the previous value “+”) of the steering-angle sign becomes opposite to the current value “−” of the steering-angle sign. Hence, at the time t1, a count-up operation of the steering-input decision preliminary counter-3 starts. At a point of time t2, the steering-input decision preliminary counter-3 becomes greater than or equal to the steering-input decision steering angular velocity state variable threshold value-3. Thus, at the time t2, the steering state variable is set to “3”, and the steering-input decision preliminary counter-3 is cleared to “0”.

### (Steering-Input Decision Flag Reset Processing)

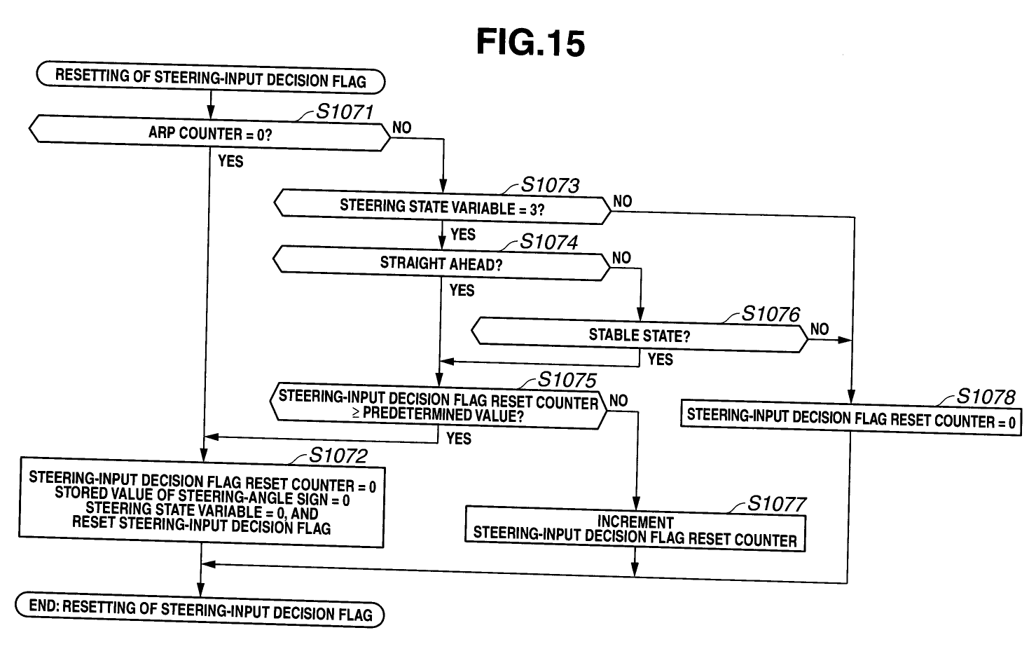

FIG. 15 shows the steering-input decision flag reset processing, executed through step S107 of FIG. 4.

At step S1071, a check is made to determine whether the ARP counter is cleared to “0”. When the answer to step S1071 is affirmative (YES), the routine proceeds to step S1072. Conversely when the answer to step S1071 is negative (NO), the routine proceeds to step S1073.

At step S1072, a steering-input decision flag reset counter is cleared to “0”, the stored value of the steering-angle sign is cleared to “0”, the steering state variable is initialized to “0”, and the steering-input decision flag is reset to “0”, and then one execution cycle of the routine terminates.

At step S1073, a check is made to determine whether the steering state variable is set to “3”. When the answer to step S1073 is affirmative (YES), the routine proceeds to step S1074. Conversely when the answer to step S1073 is negative (NO), the routine proceeds to step S1078.

At step S1074, a check is made to determine whether the vehicle is in a straight-ahead state. When the answer to step S1074 is affirmative (YES), the routine proceeds to step S1075. Conversely when the answer to step S1074 is negative (NO), the routine proceeds to step S1077. As a decision condition for determining the straight-ahead state, the following four conditions can be utilized.

(i) steering angle signal θ, whose signal value is within a predetermined value (i.e., a vehicle straight-ahead state decision steering angle threshold value);

(ii) yaw rate signal γ, whose signal value is within a predetermined value (i.e., a vehicle straight-ahead state decision yaw rate threshold value);

(iii) a yaw rate signal determined based on wheel speeds Vw, whose signal value is within the predetermined value (i.e., the vehicle straight-ahead state decision yaw rate threshold value); and

(iv) a yaw rate difference between yaw rate signal γ and a yaw rate signal determined based on wheel speeds Vw, whose difference is within a predetermined value (i.e., a vehicle straight-ahead state decision yaw rate difference threshold value-1).

In the shown embodiment, the processor of ECU 10 determines that the vehicle is in the straight-ahead state, when the above-mentioned four conditions are all satisfied. In lieu thereof, the processor may determine that the vehicle is in the straight-ahead state, when either one of these four conditions is satisfied or two or more conditions, arbitrarily selected from the four conditions, are satisfied.

At step S1075, a check is made to determine whether the steering-input decision flag reset counter is greater than or equal to a predetermined value (i.e., a steering-input decision flag reset threshold value). When the answer to step S1075 is affirmative (YES), the routine proceeds to step S1072. Conversely when the answer to step S1075 is negative (NO), the routine proceeds to step S1077.

At step S1076, a check is made to determine whether the vehicle is in a vehicle-behavior stable state. When the answer to step S1076 is affirmative (YES), the routine proceeds to step S1075. Conversely when the answer to step S1076 is negative (NO), the routine proceeds to step S1078. As a decision condition for determining the vehicle-behavior stable state, the following three conditions can be utilized.

(i) a yaw rate difference between yaw rate signal γ and a yaw rate signal determined based on steering angle θ, whose difference is within a predetermined value (i.e., a vehicle stable state decision yaw rate difference threshold value-1);

(ii) a yaw rate difference between a yaw rate signal determined based on steering angle θ and a yaw rate signal determined based on lateral acceleration Yg, whose difference is within the predetermined value (i.e., the vehicle stable state decision yaw rate difference threshold value-1); and

(iii) a yaw rate difference between yaw rate signal γ and a yaw rate signal determined based on lateral acceleration Yg, whose difference is within the predetermined value (i.e., the vehicle stable state decision yaw rate difference threshold value-1).

In the shown embodiment, the processor of ECU 10 determines that the vehicle is in the vehicle-behavior stable state, when the above-mentioned three conditions are all satisfied. In lieu thereof, the processor may determine that the vehicle is in the vehicle-behavior stable state, when either one of these three conditions is satisfied or two conditions, arbitrarily selected from the three conditions, are satisfied.

At step S1077, the steering-input decision flag reset counter is incremented, and then one execution cycle of the routine terminates.

At step S1078, the steering-input decision flag reset counter is cleared to “0”, and then one execution cycle of the routine terminates.

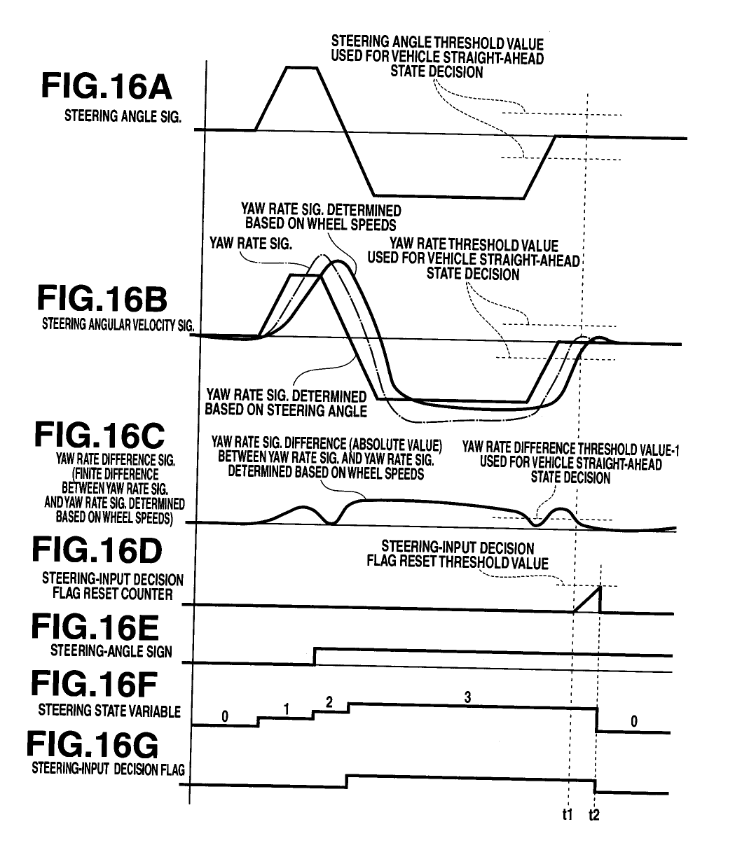

As seen from the time charts of FIGS. 16A-16G, illustrating a variation in steering state variable and a variation in counted value of the steering-input decision flag reset counter, in the case that the vehicle has been transferred to a straight-ahead state after a steering input by which “rollover” can be predicted, at a point of time t1 steering angle signal θ becomes within the vehicle straight-ahead state decision yaw rate threshold value, and yaw rate signal γ becomes within the vehicle straight-ahead state decision yaw rate threshold value, and the yaw rate signal determined based on wheel speeds Vw becomes within the vehicle straight-ahead state decision yaw rate threshold value, and the yaw rate difference between yaw rate signal γ and the yaw rate signal determined based on wheel speeds Vw becomes within the vehicle straight-ahead state decision yaw rate difference threshold value-1. Hence, at the time t1, the processor of ECU 10 determines that the vehicle is in the straight-ahead state and thus a count-up operation of the steering-input decision flag reset counter starts. At a point of time t2, the steering-input decision flag reset counter becomes greater than or equal to the steering-input decision flag reset threshold value. Thus, at the time t2, the steering state variable is initialized to “0”, and the steering-input decision flag is reset to “0”.

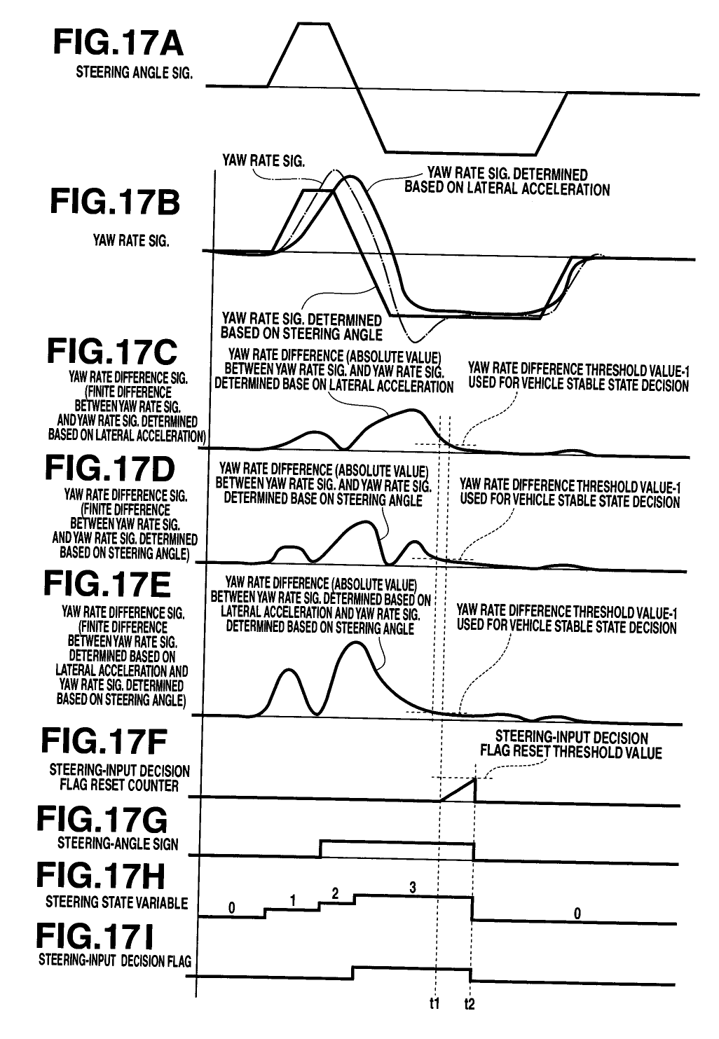

As seen from the time charts of FIGS. 17A-17I, illustrating a variation in steering state variable and a variation in counted value of the steering-input decision flag reset counter, in the case that the vehicle has been transferred to a vehicle-behavior stable state after a steering input by which “rollover” can be predicted, at a point of time t1 the yaw rate difference between yaw rate signal γ and the yaw rate signal determined based on steering angle θ becomes within the vehicle stable state decision yaw rate difference threshold value-1, and the yaw rate difference between the yaw rate signal determined based on steering angle θ and the yaw rate signal determined based on lateral acceleration Yg becomes within the vehicle stable state decision yaw rate difference threshold value-i, and the yaw rate difference between yaw rate signal γ and the yaw rate signal determined based on lateral acceleration Yg becomes within the vehicle stable state decision yaw rate difference threshold value-1. Hence, at the time t1, the processor of ECU 10 determines that the vehicle is in the vehicle-behavior stable state and thus a count-up operation of the steering-input decision flag reset counter starts. At a point of time t2, the steering-input decision flag reset counter becomes greater than or equal to the steering-input decision flag reset threshold value. Thus, at the time t2, the steering state variable is initialized to “0”, and the steering-input decision flag is reset to “0”.

### [ARP Control Execution Decision Processing]

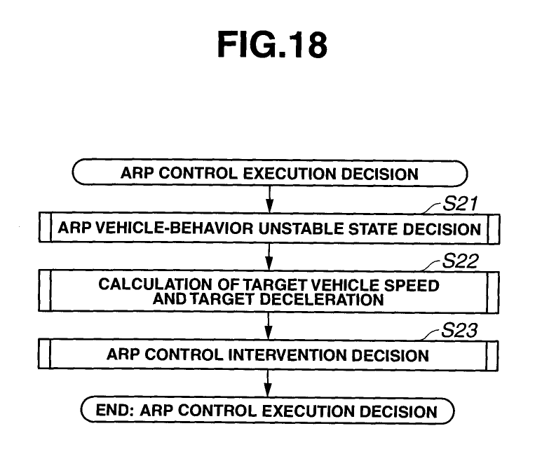

Referring now to FIG. 18, there is shown the flow of ARP control execution decision processing carried out by ARP control execution decision section 25.

At step S21, ARP vehicle-behavior unstable decision processing is carried out by ARP vehicle-behavior unstable state decision section 27.

At step S22, target vehicle speed and target deceleration calculation processing is carried out by target vehicle speed and target deceleration calculation section 28.

At step S23, ARP control intervention decision processing is carried out by ARP control intervention decision section 29.

The ARP vehicle-behavior unstable decision processing, the target vehicle speed and target deceleration calculation processing, and the ARP control intervention decision processing are hereunder described in detail, in that order.

### (ARP Vehicle-Behavior Unstable Decision Processing)

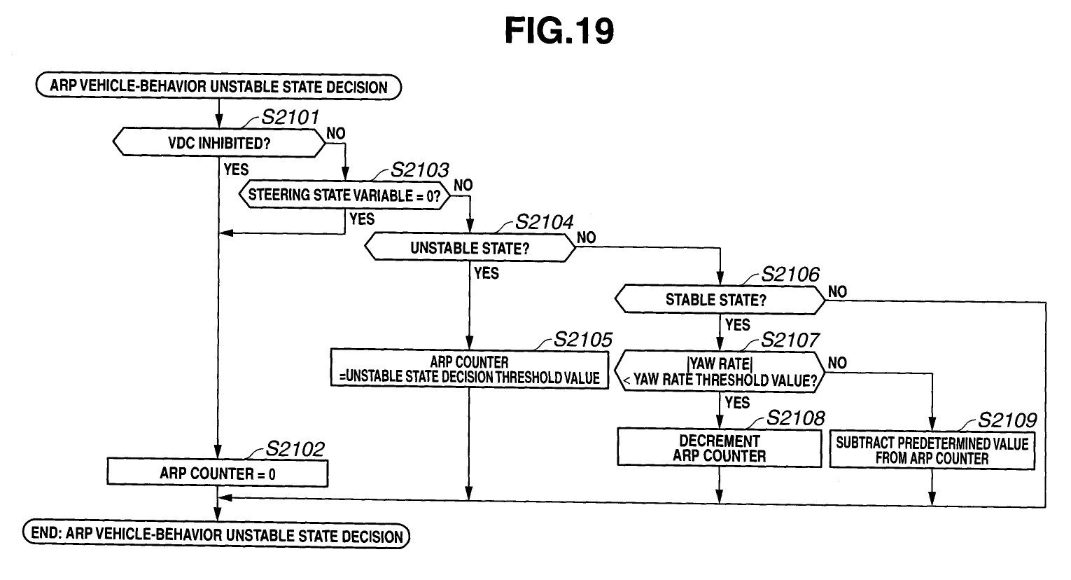

Referring now to FIG. 19, there is shown the flow of vehicle-behavior unstable decision processing.

At step S2101, a check is made to determine whether the vehicle dynamics control (VDC) system is in a disabled state (an inhibition state). When the answer to step S2101 is affirmative (YES), the routine proceeds to step S2102. Conversely when the answer to step S2101 is negative (NO), the routine proceeds to step S2103. In the case that ARP control is executed regardless of whether the VDC system is in an enabled state or a disabled state (an inhibition state), this step (i.e., step S2101) is omitted. In such a case, the vehicle-behavior unstable decision routine may start from step S2103.

At step S2102, the ARP counter is cleared to “0” and then one execution cycle of the routine terminates.

At step S2103, a check is made to determine whether the steering state variable is initialized to “0”. When the answer to step S2103 is affirmative (YES), the routine proceeds to step S2102. Conversely when the answer to step S2103 is negative (NO), the routine proceeds to step S2104.

At step S2104, a check is made to determine whether the vehicle behavior is unstable. When the answer to step S2104 is affirmative (YES), the routine proceeds to step S2105. Conversely when the answer to step S2104 is negative (NO), the routine proceeds to step S2106. As a decision condition for determining the vehicle-behavior unstable state, the following five conditions can be utilized.

(i) an absolute value |γ| of yaw rate signal γ, which absolute value |γ| is greater than a signal obtained by multiplying a gain (e.g., a value of “1” or more) with a yaw rate signal calculated and determined based on an absolute value |Yg| of lateral acceleration Yg;

(ii) the sign of yaw rate signal γ identical to the sign of lateral acceleration Yg;

(iii) the steering state variable set to “1”;

(iv) an absolute value of a lateral acceleration difference between a lateral acceleration signal obtained by converting yaw rate signal γ into a lateral acceleration and lateral acceleration signal Yg, which absolute value is greater than or equal to a predetermined value (i.e., an ARP counter set threshold value-1); and

(v) an absolute value of a lateral acceleration difference between a lateral acceleration signal obtained by converting steering angle θ into a lateral acceleration and lateral acceleration signal Yg, which absolute value is greater than or equal to a predetermined value (i.e., an ARP counter set threshold value-2).

In the shown embodiment, the processor of ECU 10 determines that the vehicle is in the vehicle-behavior unstable state, when the above-mentioned five conditions are all satisfied. In lieu thereof, the processor may determine that the vehicle is in the vehicle-behavior unstable state, when either one of these five conditions is satisfied or two or more conditions, arbitrarily selected from the five conditions, are satisfied.

At step S2105, the ARP counter is set to an unstable state decision threshold value, and then one execution cycle of the routine terminates.

At step S2106, a check is made to determine whether the vehicle behavior is stable. When the answer to step S2106 is affirmative (YES), the routine proceeds to step S2107. Conversely when the answer to step S2106 is negative (NO), one execution cycle of the routine terminates. As a decision condition for determining the vehicle-behavior stable state, the following four conditions can be utilized.

(i) an absolute value |γ| of yaw rate signal γ, which absolute value |γ| is less than a signal obtained by multiplying a gain (e.g., a value of “1” or less) with a yaw rate signal calculated and determined based on an absolute value |Yg| of lateral acceleration Yg;

(ii) the sign of steering angle signal θ identical to the sign of lateral acceleration Yg;

(iii) the ARP counter whose counted value is greater than or equal to “0”; and

(iv) the steering state variable set to a value of “2” or more.

In the shown embodiment, the processor of ECU 10 determines that the vehicle is in the vehicle-behavior stable state, when the above-mentioned four conditions are all satisfied. In lieu thereof, the processor may determine that the vehicle is in the vehicle-behavior stable state, when either one of these four conditions is satisfied or two or more conditions, arbitrarily selected from the four conditions, are satisfied.

At step S2107, a check is made to determine whether the absolute value |γ| of yaw rate signal γ is less than a predetermined yaw rate threshold value. When the answer to step S2107 is affirmative (YES), the routine proceeds to step S2108. Conversely when the answer to step S2107 is negative (NO), the routine proceeds to step S2109.

At step S2108, the ARP counter is decremented, and then one execution cycle of the routine terminates.

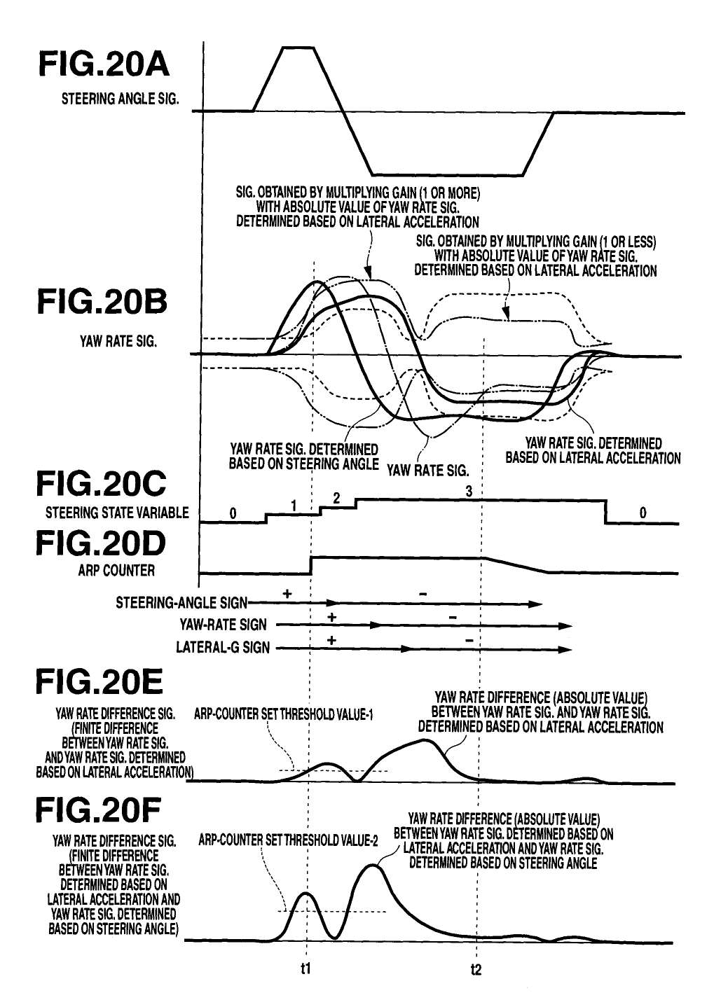

As seen from the time charts of FIGS. 20A-20F, illustrating a variation in counted value of the ARP counter, in the presence of a steering input by which “rollover” can be predicted, at a point of time t1 the absolute value |γ| of yaw rate signal γ becomes greater than a signal obtained by multiplying a gain (e.g., a value of “1” or more) with a yaw rate signal calculated and determined based on the absolute value |Yg| of lateral acceleration Yg, and the sign of yaw rate signal γ becomes identical to the sign of lateral acceleration Yg, and the steering state variable becomes set to “1”, and the absolute value of the lateral acceleration difference between a lateral acceleration signal obtained by converting yaw rate signal γ into a lateral acceleration and lateral acceleration signal Yg becomes greater than or equal to the ARP counter set threshold value-1, and the absolute value of the lateral acceleration difference between a lateral acceleration signal obtained by converting steering angle θ into a lateral acceleration and lateral acceleration signal Yg becomes greater than or equal to the ARP counter set threshold value-2. Hence, at the time t1, the processor of ECU 10 determines that the vehicle is in the vehicle-behavior unstable state and thus the ARP counter is set to the unstable state decision threshold value. At a point of time t2, the absolute value |γ| of yaw rate signal γ becomes less than a signal obtained by multiplying a gain (e.g., a value of “1” or more) with a yaw rate signal calculated and determined based on the absolute value |Yg| of lateral acceleration Yg, and the sign of steering angle signal θ becomes identical to the sign of lateral acceleration Yg, and the ARP counter becomes greater than or equal to “0”, and the steering state variable becomes set to a value of “2” or more. Hence, at the time t2, the processor of ECU 10 determines that a transition from the vehicle-behavior unstable state to the vehicle-behavior stable state occurs and thus the ARP counter decrement operation starts.

### (Target Vehicle Speed and Target Deceleration Calculation Processing)

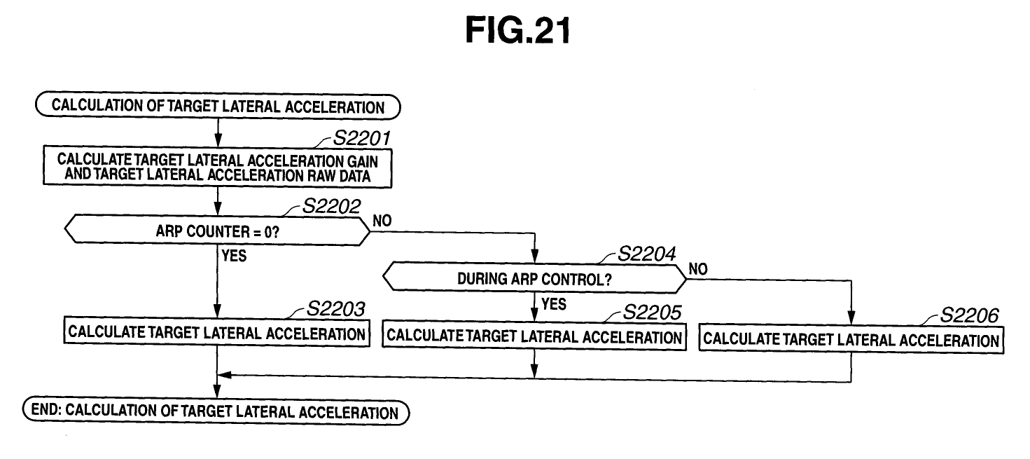

Referring now to FIG. 21, there is shown the flow of target lateral acceleration calculation processing.

At step S2201, a target lateral acceleration gain and a target lateral acceleration raw data are calculated. Thereafter, step S2202 occurs. In the shown embodiment, the technical term “raw data” means an analogue value, before giving the process of analog-to-digital conversion and/or the process of filtering after arithmetic processing.

The target lateral acceleration gain is calculated or retrieved from a preprogrammed target lateral acceleration gain table (or a preprogrammed target lateral acceleration gain map) showing how a target lateral acceleration gain has to be varied with respect to an absolute value of a maximum value of a difference between target yaw rate signal and yaw rate signal γ. The absolute value of the maximum value of the difference between target yaw rate signal and yaw rate signal γ will be hereinafter referred to as “difference maximum value”. More concretely, regarding the preprogrammed target lateral acceleration gain table, a plurality of target lateral acceleration gains are predetermined with respect to respective difference maximum values differing from each other, and thus there is a one-to-one correspondence between the target lateral acceleration gains and the difference maximum values. In the preprogrammed target lateral acceleration gain table (see FIG. 23), the difference maximum values are plotted in the axis of abscissa, whereas the corresponding target lateral acceleration gains are plotted in the axis of ordinate. An intermediate value of the plotted two adjacent target lateral acceleration gains is estimated by interpolation.

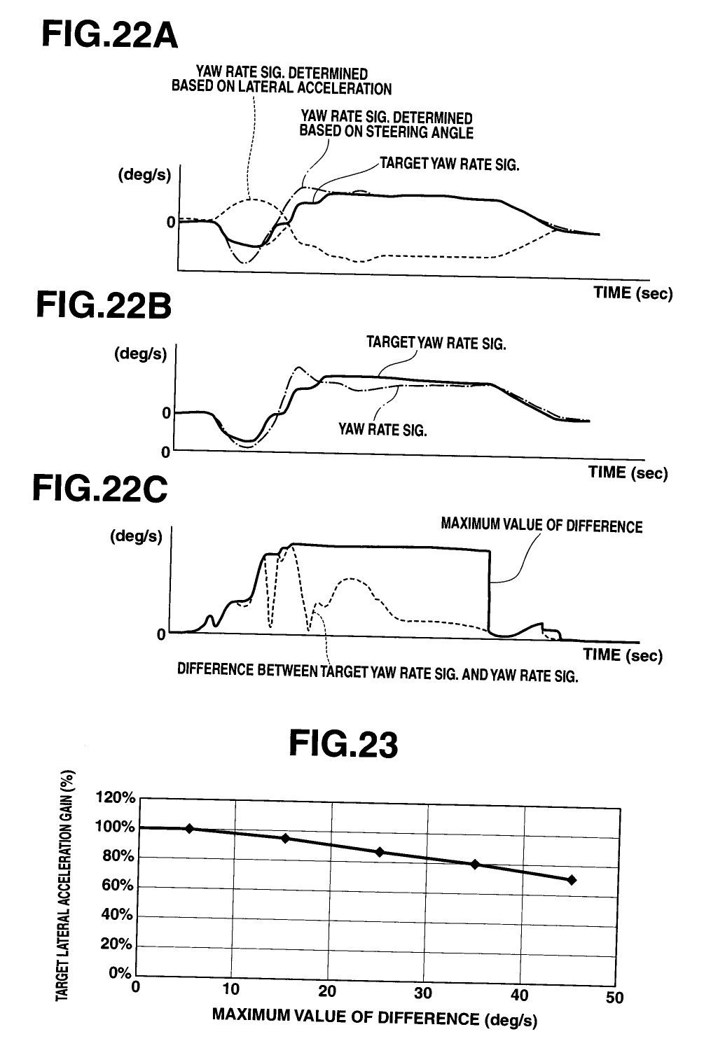

In the apparatus of the embodiment, the target yaw rate signal is calculated by synthesizing a yaw rate signal calculated and determined based on lateral acceleration signal Yg and a yaw rate signal calculated and determined based on steering angle θ (see FIG. 22A). A target yaw rate signal and yaw rate signal γ, both produced in the presence of a steering input by which “rollover” can be predicted, are indicated by signal waveforms as shown in FIG. 22B, whereas the difference maximum value between the target yaw rate signal and yaw rate signal γ is indicated by a signal waveform as shown in FIG. 22C.

As can be seen from the preprogrammed target lateral acceleration gain table shown in FIG. 23, the axis of abscissa is chosen to indicate the difference maximum value, whereas the axis of ordinate is chosen to indicate the target lateral acceleration gain. As discussed above, specified coordinates to a plurality of plotted points (five points in the shown embodiment), each point indicating a specified difference maximum value and the corresponding target lateral acceleration gain, are predetermined or preprogrammed. Intermediate values between the two adjacent points can be determined as points on the straight line interconnecting the two adjacent points, by interpolation. The target lateral acceleration gain table has a specific difference maximum value versus target lateral acceleration gain characteristic that the target lateral acceleration gain decreases, as the difference maximum value between the target yaw rate signal and yaw rate signal γ increases.

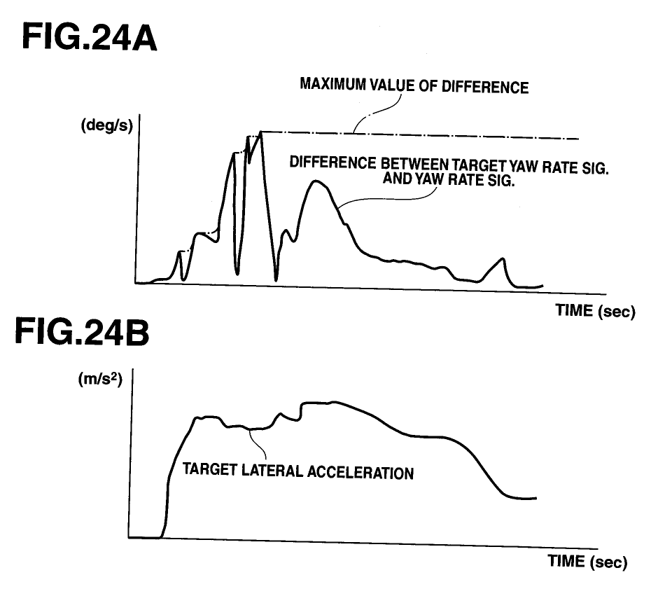

Also, at step S2201, the target lateral acceleration raw data is calculated by multiplying the calculated or retrieved target lateral acceleration gain with the calculated road-surface μ estimated value RM, that is, TARGET LATERAL ACCELERATION RAW DATA=(TARGET LATERAL ACCELERATION GAIN)×(RM). Thus, in the case of a difference maximum value between the target yaw rate signal and yaw rate signal γ as shown in FIG. 24A, a target lateral acceleration raw data, obtained as the product of the target lateral acceleration gain and road-surface μ estimated value RM, is indicated by a signal waveform as shown in FIG. 24B.

At step S2202, a check is made to determine whether the ARP counter is cleared to “0”. When the answer to step S2202 is affirmative (YES), the routine proceeds to step S2203. Conversely when the answer to step S2202 is negative (NO), the routine proceeds to step S2204.

At step S2203, road-surface μ estimated value RM is set as a current target lateral acceleration, and then one execution cycle of the routine terminates.

At step S2204, a check is made to determine whether the ARP control system is in operation (i.e., in an activated state). When the answer to step S2204 is affirmative (YES), the routine proceeds to step S2205. Conversely when the answer to step S2204 is negative (NO), the routine proceeds to step S2206.

At step S2205, a temporary target lateral acceleration is determined by a select-low process according to which a lower one of (i) the target lateral acceleration raw data and (ii) the target lateral acceleration one execution cycle before (e.g., 10 milliseconds before) is selected. Then, the temporary target lateral acceleration is processed by means of a limiter so as to limit its magnitude within a predetermined lateral acceleration range from a target lateral acceleration lower limit to a target lateral acceleration upper limit. The target lateral acceleration upper limit of the limiter is used to prevent an excessively high target lateral acceleration, which may occur owing to an increase in deceleration and/or lateral acceleration during control of the secondary side (e.g., the output stages). On the other hand, the target lateral acceleration lower limit of the limiter is used to prevent an excessively low target lateral acceleration. Thereafter, the limited target lateral acceleration, which is produced by processing the temporary target lateral acceleration by the limiter, is set as a current target lateral acceleration, and then one execution cycle of the routine terminates.

At step S2206, the target lateral acceleration raw data is processed by means of the limiter so as to limit its magnitude within the predetermined lateral acceleration range. Thereafter, the limited target lateral acceleration, which is produced by processing the target lateral acceleration raw data by the limiter, is set as a current target lateral acceleration, and then one execution cycle of the routine terminates.

Next, a target vehicle speed raw data is calculated by dividing the current target lateral acceleration calculated by the target lateral acceleration calculation procedures of FIG. 21 by a target vehicle speed raw data calculation yaw rate, that is, TARGET VEHICLE SPEED RAW DATA=(TARGET LATERAL ACCELERATION)/(TARGET VEHICLE SPEED RAW DATA CALCULATION YAW RATE). The target vehicle speed raw data calculation yaw rate is determined by a select-high process according to which a higher one of (i) the absolute value |γ| of yaw rate signal γ and (ii) the absolute value of a yaw rate signal calculated and determined based on steering angle signal θ is selected. That is, the target vehicle speed raw data is set or determined based on the vehicle dynamic behavior estimated or assumed by steering angle signal θ as well as the actual vehicle dynamic behavior (i.e., the detected yaw rate signal γ).

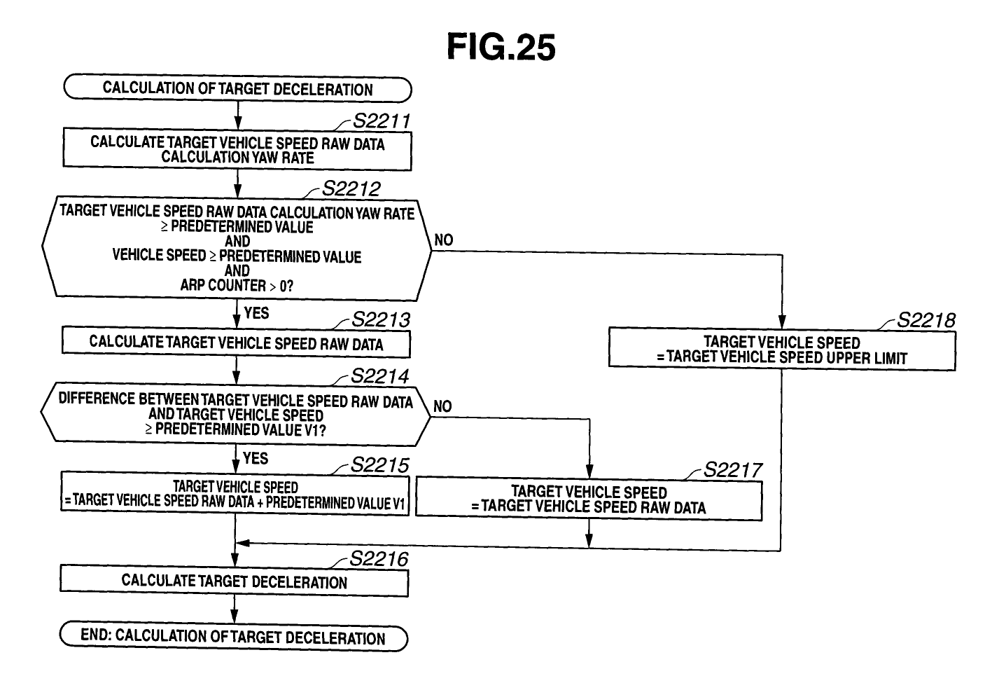

The details of the method to calculate the target deceleration are hereunder described in reference to the flowchart of FIG. 25.

At step S2211, a target vehicle speed raw data calculation yaw rate is calculated and determined by the previously-discussed select-high process MAX(ABSOLUTE VALUE |γ| OF YAW RATE SIGNAL, ABSOLUTE VALUE OF YAW RATE SIGNAL CALCULATED BASED ON STEERING ANGLE θ). Thereafter, step S2212 occurs.

At step S2212, a check is made to determine whether the following three conditions are all satisfied.

(i) a target vehicle speed raw data calculation yaw rate, which yaw rate is greater than or equal to a predetermined value (i.e., a target vehicle speed raw data calculation yaw rate threshold value);

(ii) a vehicle speed, which speed value is greater than or equal to a predetermined value (i.e., a specified speed value reduced to such an extent that there is a less risk of “rollover”); and

(iii) the ARP counter whose counted value is greater than “0”.

At step S2213, the target vehicle speed raw data is calculated based on the calculated value obtained by dividing the current target lateral acceleration by the target vehicle speed raw data calculation yaw rate as well as a target vehicle speed upper limit such as 255 km/h. That is, the target vehicle speed raw data is determined by a select-low process according to which a lower one of (i) the calculated value obtained by dividing the current target lateral acceleration by the target vehicle speed raw data calculation yaw rate and (ii) the target vehicle speed upper limit (e.g., 255 km/h) is selected.

At step S2214, a check is made to determine whether the difference between the target vehicle speed raw data and the target vehicle speed is higher than or equal to a predetermined value V1 (a target vehicle speed increment gradient). When the answer to step S2214 is affirmative (YES), the routine proceeds to step S2215. Conversely when the answer to step S2214 is negative (NO), the routine proceeds to step S2217.

At step S2215, the summed value of the target vehicle speed raw data and the predetermined value V1 is set as a target vehicle speed, that is, TARGET VEHICLE SPEED=(TARGET VEHICLE SPEED RAW DATA)+(PREDETERMINED VALUE V1). Thereafter, step S2216 occurs.

At step S2216, the target deceleration is calculated, and then one execution cycle of the routine terminates. To calculate the target deceleration, first, a target deceleration calculation vehicle speed difference is calculated by subtracting the target vehicle speed from an estimated vehicle-body velocity calculated or estimated based on the detected wheel speeds Vw. Then, the target deceleration is determined by a select-low process according to which a lower one of (i) the calculated value obtained by dividing the calculated target deceleration calculation vehicle speed difference by a decelerating time corresponding to a rate at which the target deceleration calculation vehicle speed difference must be reduced to zero and (ii) a target deceleration upper limit is selected.

At step S2217, the target vehicle speed raw data is set as a current value of the target vehicle speed, and then the routine proceeds to step S2216.

At step S2218, the target vehicle speed upper limit (e.g., 255 km/h) is set as a current value of the target vehicle speed, and then the routine proceeds to step S2216.

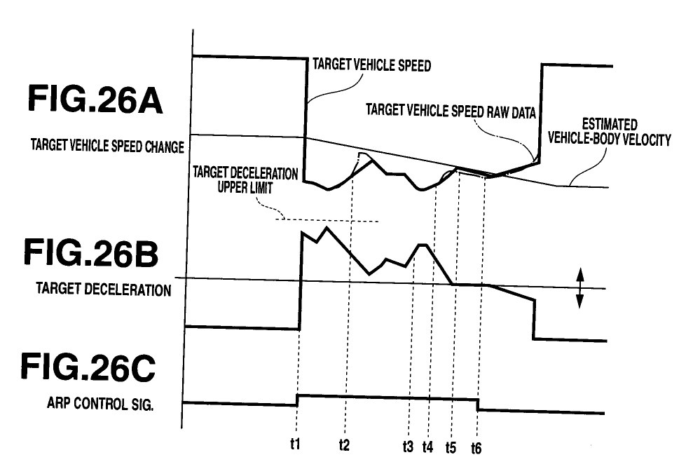

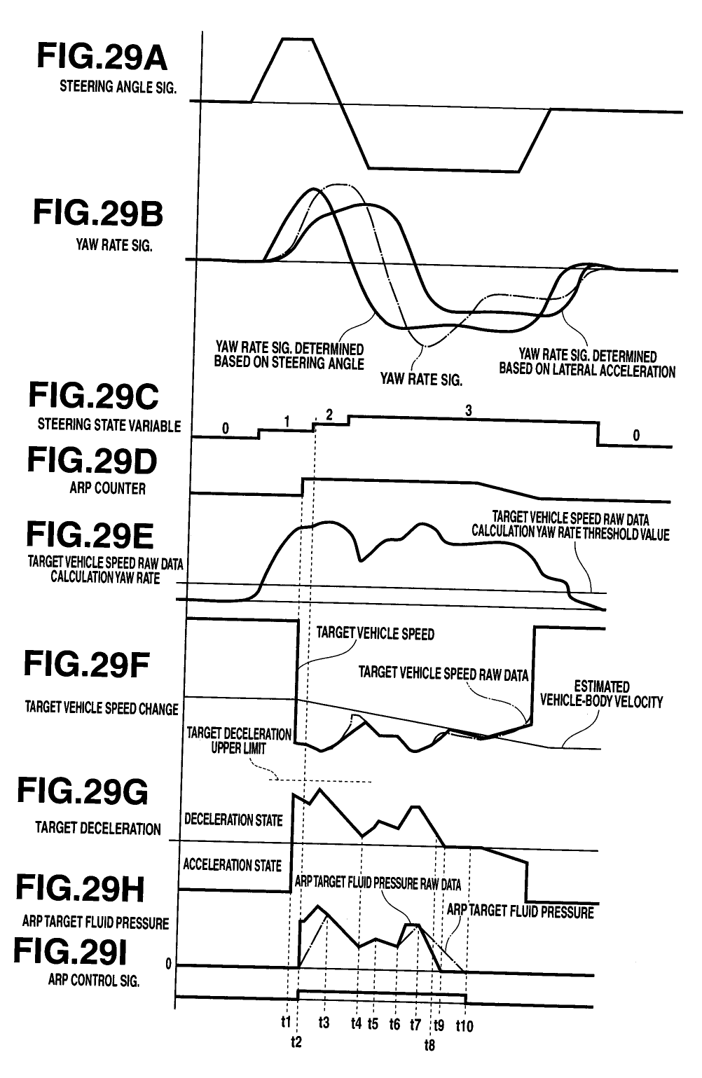

As described later, in the case of ARP control (front wheel-brake cylinder pressure buildup control) executed by the apparatus of the embodiment, the ARP control mode becomes activated (ON) at a point of time when the target fluid pressure becomes higher than or equal to a master-cylinder pressure. Conversely when the target fluid pressure becomes lower than the master-cylinder pressure, the ARP control mode becomes deactivated (OFF). Therefore, as seen from the time charts of FIGS. 26A-26C, illustrating an operating state of ARP control, a set state (an ON state) of an ARP control signal is maintained for a period of time from a point of time (see the time t1 of FIGS. 26A-26C) when the ARP control signal is set to activate ARP control via a point of time (see the time t5 of FIGS. 26A-26C) when the estimated vehicle-body velocity becomes identical to the target vehicle speed and thus the target deceleration calculation vehicle speed difference (the deviation between the estimated vehicle-body velocity and the target vehicle speed) becomes “0” to a point of time (see the time t10 of FIGS. 29A-29I) when an ARP target fluid pressure becomes “0”. That is, the ARP control is continuously executed for the time period t1-t10.

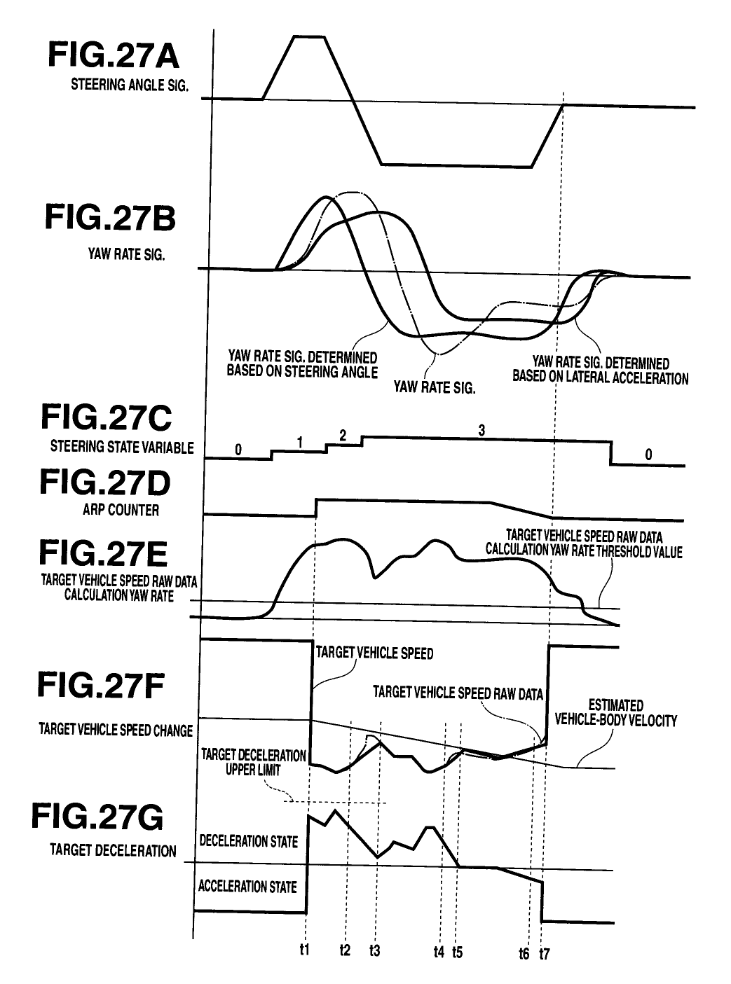

As seen from the time charts of FIGS. 27A-27G, illustrating a variation in target vehicle speed and a variation in target deceleration, during ARP control, at a point of time t1 the target vehicle speed raw data calculation yaw rate becomes greater than or equal to the target vehicle speed raw data calculation yaw rate threshold value, and the vehicle speed becomes higher than or equal to the predetermined value, and the counted value of the ARP counter becomes greater than “0”. Hence, at the time t1, the target vehicle speed and target deceleration calculation processing starts. Thereafter, the wheel-brake cylinder pressures of front road wheels 2FL-2FR can be built up or reduced, until the counted value of the ARP counter becomes “0” at a point of time t7. In the shown embodiment, on the side of a target vehicle speed increase, that is, during each of target-vehicle-speed increase time intervals (see the time intervals t2-t3, t4-t5, t6-t7 especially in FIG. 27F), a limiter processing is made to a target vehicle speed increase gradient. Thus, on the side of the target vehicle speed increase, the target vehicle speed tends to phase-retard with respect to the target vehicle speed raw data calculated based on both the target lateral acceleration and the target vehicle speed raw data calculation yaw rate.

### (ARP Control Intervention Decision Processing)

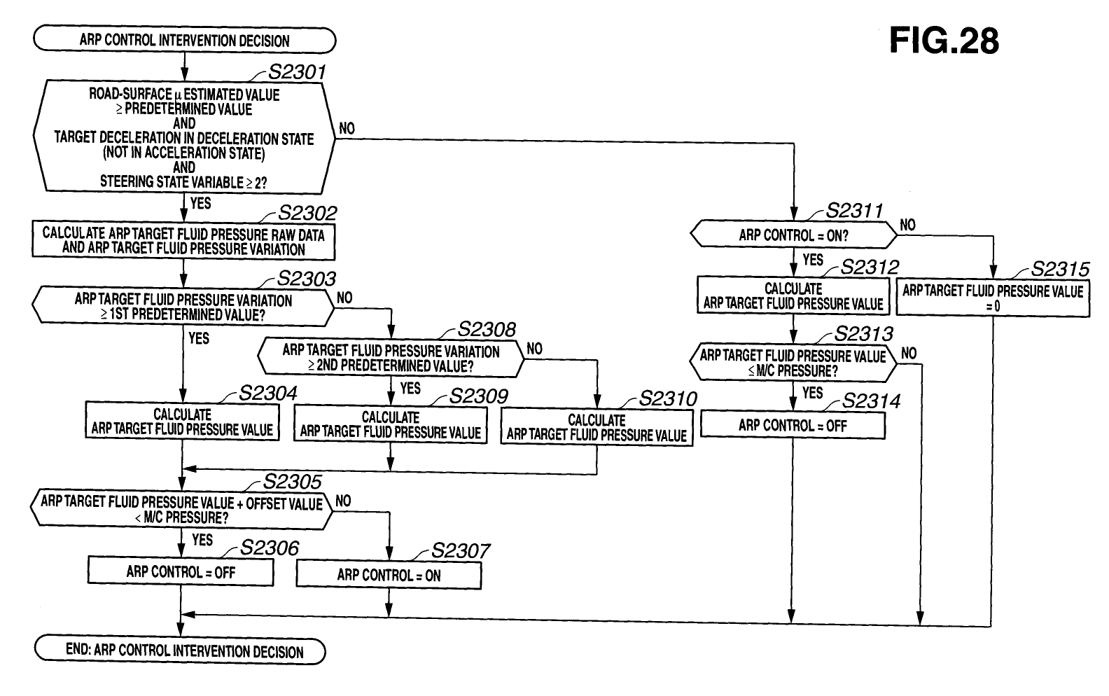

Referring now to FIG. 28, there is shown the flow of ARP control intervention decision processing.

At step S2301, a check is made to determine whether the following three conditions are all satisfied.

(i) road-surface μ estimated value RM, which magnitude is greater than or equal to a predetermined value (i.e., a steering-input decision road-surface μ threshold value);

(ii) the target deceleration, which is in a deceleration state;

(iii) the steering state variable set to “2” or more.

Hereupon, the target deceleration in a deceleration state, means that the target deceleration is set to a deceleration side, in other words, a negative longitudinal acceleration. In contrast, the target deceleration in an acceleration state, means that the target deceleration is set to an acceleration side, in other words, a positive longitudinal acceleration. When the answer to step S2301 is affirmative (YES), the routine proceeds to step S2302. Conversely when the answer to step S2301 is negative (NO), the routine proceeds to step S2311.

At step S2302, an ARP target fluid pressure raw data and an ARP target fluid pressure variation are calculated. Thereafter, step S2303 occurs. The ARP target fluid pressure raw data is determined by a select-low process according to which a lower one of (i) the product of a brake coefficient and the target deceleration and (ii) a target fluid pressure upper limit is selected. On the other hand, the ARP target fluid pressure variation is calculated as a subtracted value, obtained by subtracting the ARP target fluid pressure value from the ARP target fluid pressure raw data.

At step S2303, a check is made to determine whether the ARP target fluid pressure variation is greater than or equal to a first predetermined value, in other words, whether the ARP target fluid pressure is in a pressure buildup state. When the answer to step S2303 is affirmative (YES), the routine proceeds to step S2304. Conversely when the answer to step S2303 is negative (NO), the routine proceeds to step S2308.

At step S2304, a summed value, obtained by adding the first predetermined value to the ARP target fluid pressure value one execution cycle before (i.e., the previous value of ARP target fluid pressure), is set as a current ARP target fluid pressure value. Thereafter, step S2305 occurs.

At step S2305, a check is made to determine whether a summed value, obtained by adding an offset value to the ARP target fluid pressure value, is less than a master-cylinder pressure (exactly, an estimated master-cylinder pressure). When the answer to step S2305 is affirmative (YES), the routine proceeds to step S2306. Conversely when the answer to step S2305 is negative (NO), the routine proceeds to step S2307. A sensor signal from a master-cylinder pressure sensor (not shown) may be used instead of the previously-noted estimated master-cylinder pressure. In lieu thereof, the estimated master-cylinder pressure may be estimated or determined based on a stroke signal from brake-pedal stroke sensor 5.

At step S2306, the ARP control mode becomes deactivated

(OFF), and then one execution cycle of the routine terminates.

At step S2307, the ARP control mode becomes activated (ON), and then one execution cycle of the routine terminates.

At step S2308, a check is made to determine whether the ARP target fluid pressure variation is less than or equal to a second predetermined value, in other words, whether the ARP target fluid pressure is in a pressure reduction state. When the answer to step S2308 is affirmative (YES), the routine proceeds to step S2309. Conversely when the answer to step S2308 is negative (NO), the routine proceeds to step S2310.

At step S2309, a subtracted value, obtained by subtracting the second predetermined value from the ARP target fluid pressure value one execution cycle before (i.e., the previous value of ARP target fluid pressure), is set as a current ARP target fluid pressure value. Thereafter, step S2305 occurs.

At step S2310, a summed value, obtained by adding the ARP target fluid pressure variation to the ARP target fluid pressure raw data, is set as a current ARP target fluid pressure value. Thereafter, step S2305 occurs.

At step S2311, a check is made to determine whether the ARP control mode is activated (ON). When the answer to step S2311 is affirmative (YES), the routine proceeds to step S2312. Conversely when the answer to step S2311 is negative (NO), the routine proceeds to step S2315.

At step S2312, the ARP target fluid pressure value is determined by a select-low process according to which a lower one of (i) the subtracted value, obtained by subtracting the second predetermined value from the ARP target fluid pressure value one execution cycle before (i.e., the previous value of ARP target fluid pressure), and (ii) “0” is selected. Thereafter, step S2313 occurs.

At step S2313, a check is made to determine whether the ARP target fluid pressure value is less than or equal to the estimated master-cylinder pressure. When the answer to step S2313 is affirmative (YES), the routine proceeds to step S2314. Conversely when the answer to step S2313 is negative (NO), one execution cycle of the routine terminates.

At step S2314, the ARP control mode becomes deactivated (OFF), and then one execution cycle of the routine terminates.

At step S2315, the ARP target fluid pressure value is cleared to “0”, and then one execution cycle of the routine terminates.

As seen from the time charts of FIGS. 29A-29I, illustrating a variation in ARP target fluid pressure and a variation in ARP control signal, during ARP control, at a point of time t1 the target vehicle speed raw data calculation yaw rate becomes greater than or equal to the target vehicle speed raw data calculation yaw rate threshold value, and the vehicle speed becomes higher than or equal to the predetermined value, and the counted value of the ARP counter becomes greater than “0”. Hence, at the time t1, the target deceleration calculation processing starts. Thereafter, at a point of time t2, the ARP control mode becomes activated (ON). For a period of time t2-t3 from the time t2 to a point of time t3, the ARP target fluid pressure variation, which can be derived as a difference between the ARP target vehicle speed raw data and the ARP target fluid pressure value, becomes higher than or equal to the first predetermined value, and thus the ARP target fluid pressure value tends to gradually increase, while its increasing rate is limited by the first predetermined value. At the time t3, the ARP target fluid pressure variation becomes less than the first predetermined value and greater than the second predetermined value. Thus, for a period of time t3-t4 from the time t3 to a point of time t4, the ARP target fluid pressure value tends to reduce, while following the ARP target fluid pressure raw data. For a period of time from the time t4 to a point of time t5, the target deceleration becomes kept in the deceleration state. For a period of time from the time t5 to a point of time t6, the ARP target fluid pressure variation becomes less than the first predetermined value and greater than the second predetermined value, the ARP target fluid pressure value varies while following the ARP target fluid pressure raw data. For a period of time from the time t6 to a point of time t7, the ARP target fluid pressure variation becomes greater than the first predetermined value, and thus the ARP target fluid pressure value tends to gradually increase, while its increasing rate is limited by the first predetermined value. For a period of time from the time t7 to a point of time t8, the ARP target fluid pressure variation becomes less than the second predetermined value, and thus the ARP target fluid pressure value tends to gradually reduce, while its decreasing rate is limited by the second predetermined value. At the time t8, the subtracted value, obtained by subtracting the second predetermined value from the ARP target fluid pressure value one execution cycle before, becomes less than “0”, and thus the ARP target fluid pressure value tends to gradually reduce, while its decreasing rate is limited by the second predetermined value. At a point of time t9, the ARP target fluid pressure raw data becomes “0”. Thereafter, the ARP target fluid pressure continues to reduce with a limited decreasing rate and then reaches “0” at a point of time t10. Hence, at the time t10, the ARP control signal becomes switched OFF and thus the ARP control mode becomes deactivated (OFF).

### [Initial Suspension Rollover Prevention Control]

In the presence of a signal output from steering-input decision section 23, indicating the steering state variable=“1”, ARP control section 22 executes initial suspension rollover prevention control, according to which compression-side damping forces of the two suspensions associated with the outside wheels turning can be varied to higher damping forces, as compared to the magnitudes of the compression-side damping forces of the outside-wheel-suspensions produced during normal control. The initial suspension rollover prevention control is repeatedly executed, until the steering-input decision flag is reset to “0” by steering-input decision section 23.

### [Initial Steering Rollover Prevention Control]

In the presence of a signal output from ARP vehicle-behavior unstable state decision section 27, indicating the ARP counter set to the unstable state decision threshold value, ARP control section 22 executes initial steering rollover prevention control, according to which a further-steering period steering assistance force can be reduced, as compared to the magnitude of a steering assistance force produced during normal control. The initial steering rollover prevention control is repeatedly executed, until the steering-input decision flag is reset to “0” by steering-input decision section 23.

Next, the operation of the ARP control apparatus of the embodiment is hereunder described in detail in reference to the time charts shown in FIGS. 30A-30J.

At a point of time t1, suppose that a driver-applied further steering action (i.e., primary avoidance steering) starts for collision avoidance (to avoid a road obstacle).

At a point of time t2, steering-input decision section 23 outputs a signal indicating the steering state variable=“1”, since a state where the steering-input decision steering angular velocity, determined based on both the sign of steering angle 0 and the steering angular velocity, is higher than or equal to the steering-input decision steering angular velocity lower limit-1, continues until the counted value of the steering-input decision preliminary counter-1 becomes greater than or equal to the steering angular velocity state variable threshold value-1. That is, on the basis of the steering angular velocity as well as steering angle θ, both representing a state of steering input (i.e., a steering pattern), an occurrence of a predetermined roll (a predetermined level of roll motion for the vehicle) can be predicted. In other words, the occurrence of “rollover” can be predicted based on the steering angular velocity and steering angle θ. Such a rollover prediction is permitted only when the steering angular velocity is higher than or equal to a preset velocity, namely, the steering-input decision steering angular velocity lower limit-1. Therefore, it is possible to enhance the accuracy of a prediction about the occurrence of the predetermined roll (the predetermined level of roll motion for the vehicle) having a possibility of “rollover”. Additionally, such a rollover prediction starts, after a predetermined elapsed time has expired from the starting point (i.e., the time t1) of the driver-applied further steering action, in other words, after the specified condition where the steering-input decision preliminary counter-1 becomes greater than or equal to the steering-input decision steering angular velocity state variable threshold value-1 has been satisfied. Thus, it is possible to more greatly enhance the accuracy of a rollover prediction, while preventing an erroneous rollover decision, which may occur owing to noise in the vehicle sensor system. Also, ARP control section 22 is configured to initiate, responsively to a signal output from steering-input decision section 23 indicating the steering state variable=“1”, initial suspension rollover prevention control, according to which compression-side damping forces of the two suspensions associated with the outside wheels turning can be varied to higher damping forces, as compared to the magnitudes of the compression-side damping forces of the outside-wheel-suspensions produced during normal control. By virtue of such initial suspension rollover prevention control, it is possible to increase a roll stiffness of the vehicle in cornering, thus effectively suppressing an undesirable vehicle-body attitude change, in other words, an undesirable roll motion. This contributes to rapid stabilization of the vehicle dynamic behavior.

At a point of time t3, steering angle θ is kept constant by the driver.

At a point of time t4, the absolute value |γ| of yaw rate signal γ becomes greater than a signal obtained by multiplying a gain (e.g., a value of “1” or more) with a yaw rate signal calculated based on the absolute value |Yg| of lateral acceleration Yg, and the sign of yaw rate signal γ becomes identical to the sign of lateral acceleration Yg, and the steering state variable becomes set to “1”, and the absolute value of the lateral acceleration difference between a lateral acceleration signal obtained by converting yaw rate signal γ into a lateral acceleration and lateral acceleration signal Yg becomes greater than or equal to the ARP counter set threshold value-1, and the absolute value of the lateral acceleration difference between a lateral acceleration signal obtained by converting steering angle θ into a lateral acceleration and lateral acceleration signal Yg becomes greater than or equal to the ARP counter set threshold value-2. Hence, ARP vehicle-behavior unstable state decision section 27 determines that the vehicle behavior is unstable, and thus the ARP counter has been set to the unstable state decision threshold value. With the ARP counter set to the unstable state decision threshold value, target vehicle speed and target deceleration calculation section 28 starts target vehicle speed and target deceleration calculation processing.

Also, at the point of time t4, ARP control section 22 executes, responsively to the ARP counter set to the unstable state decision threshold value, initial steering rollover prevention control, according to which a further-steering period steering assistance force can be reduced, as compared to the magnitude of a steering assistance force produced during normal control. That is, under a condition where the vehicle behavior becomes transferred to an unstable state, as a result of execution of initial steering rollover prevention control it becomes hard to turn steering wheel 12 by the driver because of the appropriately reduced steering assistance force, thereby effectively suppressing a degree of the driver-applied further steering action. Thus, it is possible to suppress the vehicle dynamic behavior from transferring to a more unstable state during the further steering action.

At a point of time t5, suppose that a driver-applied steering-back action (i.e., secondary avoidance steering) starts.

At a point of time t6, steering-input decision section 23 outputs a signal indicating the steering state variable=“2”, since a state where the steering-input decision steering angular velocity is lower than or equal to the steering-input decision steering angular velocity upper limit-2, continues until the counted value of the steering-input decision preliminary counter-2 becomes greater than or equal to the steering angular velocity state variable threshold value-2. Under these conditions, the target deceleration becomes kept in the deceleration state, and the steering state variable becomes “2” or more. Hence, ARP control intervention decision section 29 makes a rollover decision that “rollover” of the vehicle will occur. Responsively to such a rollover decision performed by ARP control intervention decision section 29, the ARP control mode becomes activated (ON), and as a result ARP control is initiated in such a manner as to positively apply braking forces, which magnitudes are determined based on the calculated target deceleration, to front-left and front-right road wheels 2FL-2FR.

That is to say, according to the vehicle rollover prevention control of the ARP control system of the embodiment, the previously-noted rollover decision is made only when a driver-applied steering-back action has been detected during a time period that a predetermined vehicle behavior (i.e., a vehicle-behavior unstable state) is occurring after the rollover prediction as discussed above. When the rollover decision that “rollover” of the vehicle will occur has been satisfied, the ARP control mode can be activated (ON). For the reasons discussed above, as compared to a typical rollover prevention control system that active rollover prevention control is initiated by braking force application immediately after execution of a rollover prediction, the ARP control apparatus of the embodiment can more greatly improve or enhance the accuracy of a rollover decision. Hence, it is possible to suppress an excessive braking force application, which would occur due to unnecessary or wasteful intervention of active rollover prevention control.

Furthermore, in the ARP control apparatus of the embodiment, braking forces are positively applied to front-left and front-right road wheels 2FL-2FR during ARP control. As compared to a typical rollover prevention control system that braking forces are applied to respective outside road wheels turning, the ARP control apparatus of the embodiment can more quickly slow down vehicle speed, thus ensuring earlier stabilization of the vehicle dynamic behavior.

Also, ARP control intervention decision section 29 is configured to keep the ARP control function disengaged (disabled) when road-surface μ estimated value RM is less than the steering-input decision road-surface μ threshold value in the presence of a signal output from steering-input decision section 23, indicating the steering state variable=“2”, even though the target deceleration is in a deceleration state. Hereupon, the rollover experienced by the vehicle due to a steering input, by which “rollover” can be predicted, originates from the fact that a rollover threshold (or a rollover limit) is reached before reaching to a tire grip limit during cornering of the vehicle.

As is generally known, when the vehicle is traveling on low-μ roads, a tire grip limit is small. In such a case, there is a less possibility that a rollover threshold of the vehicle is reached before reaching to a tire grip limit. Thus, there is a less risk that the rollover of the vehicle will be actually reached or completed owing to a steering input by which “rollover” can be predicted. Hence, according to the ARP control system of the embodiment, when the vehicle is traveling on high-μ roads having a road-surface friction coefficient higher than a predetermined threshold value (i.e., the steering-input decision road-surface μ threshold value), the ARP control function is engaged (enabled). Conversely when the vehicle is traveling on low-μ roads having a road-surface friction coefficient lower than or equal to the predetermined threshold value, the ARP control function is disengaged or inhibited (disabled). Hence, it is possible to enhance the accuracy of a rollover decision.

At a point of time t7, steering-input decision section 23 outputs a signal indicating the steering state variable=“3”, since a state where the steering-input decision steering angular velocity is higher than or equal to the steering-input decision steering angular velocity lower limit-3, and the road-surface μ estimated value is greater than or equal to the steering-input decision road-surface μ threshold value, and the stored value (that is, the previous value “+”) of the steering-angle sign is opposite to the current value “−” of the steering-angle sign, continues until the counted value of the steering-input decision preliminary counter-3 becomes greater than or equal to the steering angular velocity state variable threshold value-3.

Hereupon, in the ARP control system of the embodiment, steering-input decision section 23 outputs a signal indicating the steering state variable=“0”, if the steering-input decision preliminary counter-2 does not yet reach the steering-input decision steering angular velocity state variable threshold value-2 for a period of time from the time when the steering state variable becomes “1” to the time when the steering-input decision clear counter-2 becomes greater than or equal to the steering-input decision clear condition threshold value-2. In a similar manner, steering-input decision section 23 outputs a signal indicating the steering state variable=“0”, if the steering-input decision preliminary counter-3 does not yet reach the steering-input decision steering angular velocity state variable threshold value-3 for a period of time from the time when the steering state variable becomes “2” to the time when the steering-input decision clear counter becomes greater than or equal to the steering-input decision clear condition threshold value-3. That is, when there is no driver-applied steering-back action after a predetermined elapsed time has expired from the point of time when it is predicted that a predetermined roll (a predetermined level of roll motion for the vehicle) occurs, the rollover prediction can be canceled. Hence, it is possible to suppress an erroneous rollover decision, which would occur due to continuous executions of the rollover prediction under a condition where an actual steering input never corresponds to a steering input by which “rollover” can be predicted.

At a point of time t8, steering angle θ is kept constant by the driver.

At a point of time t9, the vehicle behavior becomes a vehicle-behavior stable state, and thus ARP vehicle-behavior unstable state decision section 27 starts a decrement operation of the ARP counter.

At a point of time t10, the ARP counter becomes “0”, and thus steering-input decision section 23 outputs a signal indicating the steering state variable=“0”, and resets the steering-input decision flag to “0”. In this manner, initial suspension rollover prevention control, initial steering rollover prevention control, and active rollover prevention (ARP) control terminate.

In the shown embodiment, suspension control (i.e., initial suspension rollover prevention control), steering control (i.e., initial steering rollover prevention control), and brake control (i.e., active rollover prevention control) are cooperated with each other. As appreciated, it is possible to realize vehicle rollover prevention control by only the brake control. In the case of automotive vehicles each employing a vehicle dynamics control (VDC) unit, it is possible to realize or achieve the benefits of active vehicle rollover prevention control only by addition of a minimum of software, designed to perform ARP control by interacting with the brake system for use in the VDC system, thus ensuring reduced costs.

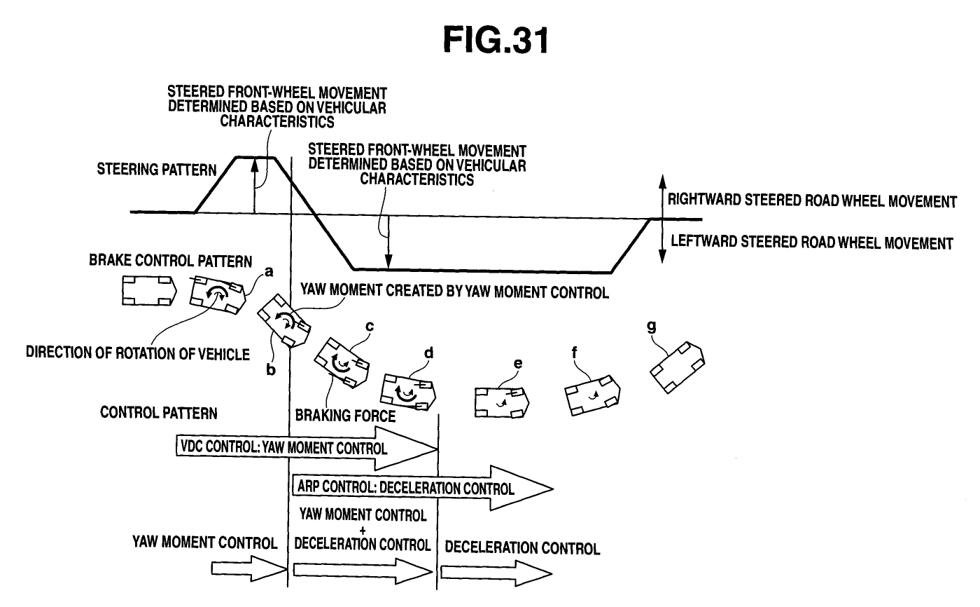

Referring now to FIG. 31, there is shown the explanatory drawing illustrating rollover prevention control action performed by the ARP control system of the embodiment. For the purpose of simplification of the disclosure, yaw moment control, i.e., VDC system control (simply, VDC control) and deceleration control (ARP control) are taken into account, but initial suspension rollover prevention control and initial steering rollover prevention control are not taken into account.

### (Yaw Moment Control Area)

In a state denoted by “a” in FIG. 31, suppose that the vehicle oversteer tendency has been strengthened due to a very quick rightward angular displacement of steering wheel 12 by the driver to avoid a road obstacle. Thus, in the state “a”, vehicle dynamics control (VDC) system comes into operation. During the VDC control, a yawing moment, acting in the direction (anti-clockwise in FIG. 31) opposing the direction of rotation (clockwise in FIG. 31) of the vehicle about the z-axis, can be produced by applying braking forces, which magnitudes are determined based on the target sideslip angle, to respective left road wheels 2FL, 2RL. At this time, the ARP control system of the embodiment initiates a rollover prediction (differing from a rollover decision) based on the steering angular velocity, but braking force application to each of front-left and front-right road wheels 2FL-2FR is not yet carried out. In contrast, suppose that a rollover decision is made at once only by a driver-applied further steering action and as a result of the rollover decision based on only the driver-applied further steering action braking forces are applied to respective front road wheels, and thereafter there is no driver-applied steering-back action. In such a case, owing to an erroneous rollover decision, an unnecessary braking force may be applied to the vehicle. To avoid this, according to the ARP control system of the embodiment, a rollover decision cannot be made only based on a driver-applied further steering action (i.e., primary avoidance steering).

(Yaw moment Control+Deceleration Control)

In a state denoted by “b” in FIG. 31, suppose that a quick driver-applied steering-back action (exactly, a quick driver-applied primary steering-back action) occurs, and thus on the basis of a steering pattern (i.e., a steering-input pattern) the ARP control system makes a rollover decision that “rollover” will occur. Therefore, at this stage, the ARP control system initiates deceleration control (ARP control) in such a manner as to apply braking forces, which magnitudes are determined based on the calculated target deceleration, uniformly to front-left and front-right road wheels 2FL-2FR. At this state “b”, the VDC system operates to apply a braking force to front-left road wheel 2FL to produce a yawing moment, acting in the direction (anti-clockwise in FIG. 31) opposing the direction of rotation (clockwise in FIG. 31) of the vehicle. Hence, the magnitude of total braking force applied to front-left road wheel 2FL becomes greater than that applied to front-right road wheel 2FR. That is, in the presence of such a rollover decision that “rollover” will occur, yaw moment control achieved by VDC system and deceleration control achieved by ARP control system are simultaneously executed.

In a state denoted by “c” and in a state denoted by “d” in FIG. 31, suppose that a continuous driver-applied steering-back action (exactly, a driver-applied secondary steering-back action subsequently to the primary steering-back action) occurs, and thus the direction of rotation of the vehicle, produced in the states “c” and “d” becomes opposite to that, produced in the state “b”. Therefore, the VDC system operates to apply a braking force, which magnitude is determined based on the target sideslip angle, to front-right road wheel 2FL. At this stages “c” and “d”, the ARP control system operates to apply braking forces having the same magnitude uniformly to front-left and front-right road wheels 2FL-2FR. Hence, the magnitude of total braking force applied to front-right road wheel 2FR becomes greater than that applied to front-left road wheel 2FL.

### (Deceleration Control Area)

In a state denoted by “e” in FIG. 31, suppose that the vehicle oversteer tendency becomes weakened and thus the vehicle behavior becomes shifted to an unstable state. Thus, braking force application, based on VDC control, terminates. At this state “e”, the ARP control system operates to gradually reduce braking forces applied to front-left and front-right road wheels 2FL-2FR.

In a state denoted by “f” in FIG. 31, the ARP control terminates. In a state denoted by “g”, the vehicle slows down (decelerates) considerably.

In the case of VDC control (yaw moment control), it is possible to suppress a vehicle's sideslip amount by braking force application to one or more left-hand road wheels in the presence of an increased oversteer tendency during a right turn. Conversely in the presence of an increased oversteer tendency during a left turn, it is possible to suppress a vehicle's sideslip amount by braking force application to one or more right-hand road wheels. Such VDC control is yaw moment control, which is based on the assumption that the vehicle traveling state continues, and aims at approaching a turning locus of the vehicle closer to a line of travel intended by the driver. In other words, the VDC control never corresponds to a control action that the vehicle can be positively decelerated. Additionally, in the case of VDC control, a target sideslip amount (a target sideslip angle) is calculated or determined based on a yaw rate of the vehicle and a lateral acceleration exerted on the vehicle. Such a VDC control action cannot follow a rapid vehicle dynamic behavior change occurring during a very quick steering action, such as an emergency steering action for road obstacle avoidance, wherein a direction of rotation of the vehicle suddenly changes. For the reasons discussed above, by VDC control, it is impossible or difficult to prevent or suppress “rollover” from occurring.

In contrast to the above, in the case of ARP control executed by the apparatus of the embodiment, in the presence of a rollover decision that “rollover” will occur, it is possible to ensure rapid stabilization of the vehicle dynamic behavior by applying braking forces uniformly to respective front road wheels 2FL-2FR for the purpose of positive vehicle deceleration, even during a very quick steering action, such as an emergency steering action, wherein a direction of rotation of the vehicle suddenly changes.

Furthermore, in the case of ARP control executed by the apparatus of the embodiment, a rollover decision is made based on a steering pattern (i.e., a driver-applied steering input), and thus it is possible to more effectively suppress “rollover” from occurring, as compared to a control system that a rollover decision is made based on a yaw rate of the vehicle and a lateral acceleration exerted on the vehicle.

Moreover, in the shown embodiment, an ARP control function and a VDC control function can be engaged (activated) simultaneously and whereby a cooperative control action of ARP control (deceleration control) and VDC control (yaw moment control) can be effectively realized. Hence, it is possible to positively decelerate the vehicle, while appropriately producing a yawing moment used to suppress a vehicle oversteer tendency, thereby ensuring earlier stabilization of the vehicle dynamic behavior.

The vehicle rollover prevention control apparatus of the embodiment can provide the following effects.

(1) The vehicle rollover prevention control apparatus of the embodiment includes a brake system configured to control a dynamic behavior of a vehicle, steering-input decision section 23 configured to make a rollover prediction, based on a driver-applied steering input, whether a predetermined level of roll motion for the vehicle occurs, and further configured to detect a driver-applied steering-back action, ARP control intervention decision section 29 configured to make a rollover decision about rollover of the vehicle when the driver-applied steering-back action has been detected, and ARP control section 22 configured to execute rollover prevention control by controlling the brake system (serving as an actuator), when it is predicted for the predetermined level of roll motion to occur by steering-input decision section 23 and the rollover decision that rollover will occur has been made by ARP control intervention decision section 29. Hereby, it is possible to enhance the accuracy of a decision about “rollover” of the vehicle. Additionally, it is possible to suppress unnecessary or wasteful intervention of rollover prevention control.

(2) As a steering angular velocity detector, which is configured to detect a steering angular velocity during a driver-applied further steering action, differentiator 26 is provided downstream of steering angle sensor 17. Steering-input decision section 23 is configured to execute the rollover prediction, when the steering angular velocity, detected by differentiator 26, is higher than or equal to a preset velocity. Hereby, it is possible to enhance the accuracy of a prediction about the occurrence of the predetermined level of roll motion having a possibility of rollover.

(3) Steering-input decision section 23 is further configured to start or trigger the rollover prediction after a predetermined elapsed time has expired from a starting point of the driver-applied steering input. Hereby, it is possible to prevent an erroneous rollover decision, which would occur owing to noise in a vehicle sensor system, and therefore it is possible to more greatly enhance the accuracy of the rollover prediction.

(4) ARP control intervention decision section 29 is further configured to cancel the rollover prediction, when there is no detection of the driver-applied steering-back action after a predetermined elapsed time has expired from a point of time when it has been predicted for the predetermined level of roll motion to occur by steering-input decision section 23. Thus, it is possible to suppress an erroneous rollover decision, which would occur due to continuous executions of the rollover prediction under a condition where an actual steering input never corresponds to a steering input by which “rollover” can be predicted.

(5) ARP control section 22 is further configured to apply braking forces to front-left and front-right road wheels 2FL-2FR of the vehicle during the rollover prevention control. Thus, it is possible to more quickly slow down vehicle speed, thereby ensuring earlier stabilization of the vehicle dynamic behavior, and effectively suppressing rollover from occurring.

(6) The vehicle rollover prevention control apparatus of the embodiment further includes road-surface μ decision section 24 configured to calculate a road-surface μ estimated value. ARP control section 22 is further configured to enable (permit) execution of the rollover prevention control when the road-surface μ estimated value, calculated by road-surface μ decision section 24, is greater than or equal to a predetermined threshold value, and configured to disable (inhibit) execution of the rollover prevention control when the road-surface μ estimated value is less than the predetermined threshold value. That is to say, during high-μ road traveling that rollover is easy to occur, execution of the rollover prevention control is permitted (enabled). Conversely during low-μ road traveling that rollover is hard to occur, execution of the rollover prevention control is inhibited (disabled). Hereby, it is possible to enhance the accuracy of a rollover decision.

(7) The vehicle rollover prevention control apparatus of the embodiment further includes variable damping force electronically-controlled suspensions 14FL-14RR, associated with respective road wheels of the vehicle. ARP control section 22 is further configured to execute initial suspension rollover prevention control according to which compression-side damping forces of the electronically-controlled suspensions associated with the outside road wheels turning are varied to higher damping forces, when it is predicted for the predetermined level of roll motion to occur by steering-input decision section 23. Hereby, it is possible to suppress an undesirable roll motion of the vehicle body prior to the driver-applied steering-back action, thus effectively suppressing the rollover of the vehicle during the steering-back action. Additionally, such an active suspension control action exerts a less influence upon vehicle deceleration, and thus the suspension control (the initial suspension rollover prevention control) would be not likely to cause the driver to feel discomfort.

(8) The vehicle rollover prevention control apparatus of the embodiment further includes a variable assistance force steering system configured to variably adjust a steering assistance force. ARP control section 22 is further configured to execute initial steering rollover prevention control according to which the steering assistance force, acting in a further steering direction, is reduced (decreasingly compensated for) from its current value, when it is predicted for the predetermined level of roll motion to occur by steering-input decision section 23. Hereby, it is possible to effectively suppress the amount (the degree) of further steering made to steering wheel 12 by the driver. Additionally, such an active steering control action (steering assistance force control) exerts a less influence upon vehicle deceleration, and thus the steering control (the initial steering rollover prevention control) would be not likely to cause the driver to feel discomfort.

(9) The vehicle rollover prevention control apparatus of the embodiment includes a brake system configured to control a dynamic behavior of a vehicle, differentiator 26 configured to detect a steering angular velocity during a driver-applied further steering action, steering angle sensor 17 configured to detect a steering angle, yaw rate sensor 15 configured to detect a yaw rate of the vehicle, acceleration sensor 16 configured to detect a lateral acceleration exerted on the vehicle, steering-input decision section 23 configured to make a prediction, based on at least a signal from the differentiator 26 and a signal from the steering angle sensor 17, whether a predetermined level of roll motion for the vehicle occurs, ARP vehicle-behavior unstable state decision section 27 configured to detect the vehicle dynamic behavior based on information from at least the yaw rate sensor 15 and the acceleration sensor 16, ARP control intervention decision section 29 configured to make a rollover decision about rollover of the vehicle when a driver-applied steering-back action has been detected for a period of time during which ARP vehicle-behavior unstable state decision section 27 determines that a specified vehicle behavior occurs, and ARP control section 22 configured to execute rollover prevention control by controlling the brake system, when the rollover decision that rollover will occur has been made by ARP control intervention decision section 29. That is to say, a possible of rollover is predicted based on at least a steering angular velocity and a steering angle, and thereafter when a driver-applied steering-back action occurs under a specified condition where the vehicle is in a vehicle-dynamic-behavior unstable state, rollover prevention control is executed (initiated). Hence, it is possible to enhance the accuracy of a decision about “rollover” of the vehicle. Additionally, it is possible to suppress unnecessary or wasteful intervention of rollover prevention control.

(10) The vehicle rollover prevention control apparatus of the embodiment further includes variable damping force electronically-controlled suspensions 14FL-14RR, associated with respective road wheels of the vehicle, and a variable assistance force steering system configured to variably adjust a steering assistance force. ARP control section 22 is further configured to execute initial suspension rollover prevention control according to which compression-side damping forces of the electronically-controlled suspensions associated with the outside road wheels turning are varied to higher damping forces, and simultaneously to execute initial steering rollover prevention control according to which the steering assistance force, acting in a further steering direction, is reduced (decreasingly compensated for) from its current value, when it is predicted for the predetermined level of roll motion to occur by steering-input decision section 23. Hereby, it is possible to suppress an undesirable roll motion of the vehicle body and simultaneously to suppress the amount (the degree) of further steering made to steering wheel 12 by the driver, thereby effectively suppress the rollover of the vehicle during the steering-back action. Additionally, each of such an active suspension control action and such an active steering control action (steering assistance force control) exerts a less influence upon vehicle deceleration, and thus the suspension control (the initial suspension rollover prevention control) as well as the steering control (the initial steering rollover prevention control) would be not likely to cause the driver to feel discomfort.

(11) According to a vehicle rollover prevention control method of the embodiment, the method includes executing a rollover prediction, based on a steering angular velocity of a vehicle during a driver-applied further steering action, whether a high level of roll motion for the vehicle occurs, and executing (initiating) rollover prevention control when a driver-applied steering-back action has been detected after the rollover prediction has been satisfied. Hereby, it is possible to enhance the accuracy of a decision about “rollover” of the vehicle. Additionally, it is possible to suppress unnecessary or wasteful intervention of rollover prevention control.

(12) The vehicle rollover prevention control method of the embodiment further includes executing at least one of (i) suspension control for variable damping force electronically-controlled suspensions 14FL-14RR, associated with respective road wheels of the vehicle, and (ii) steering control for a variable assistance force steering system, after the rollover prediction has been satisfied and before the rollover prevention control. Hereby, it is possible to ensure earlier stabilization of the vehicle dynamic behavior at an earlier timing before a rollover decision is made, thus effectively suppressing the rollover of the vehicle during the steering-back action.

### [Modifications]

In the shown embodiment, the hydraulically-operated brake system is used as a vehicle-dynamics-control (VDC) actuator as well as an ARP control actuator. Suppose that the fundamental inventive concept of the invention is applied to automotive vehicles wherein front road wheels are can be driven by means of electric motors (e.g., in-wheel motors). In such a case, for the purpose of vehicle dynamic behavior control (active rollover prevention control as well as vehicle dynamics control), a regenerative braking action, produced by the electric motors (e.g., in-wheel motors), may be utilized.

The entire contents of Japanese Patent Application No. 2009-013254 (filed Jan. 23, 2009) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A vehicle rollover prevention control apparatus comprising:
an actuator configured to control a dynamic behavior of a vehicle;
a rollover prediction section configured to make a rollover prediction, based on a driver-applied steering input, whether a predetermined level of roll motion for the vehicle occurs;
a steering-back detection section configured to detect a driver-applied steering-back action;
a rollover decision section configured to make a rollover decision about rollover of the vehicle when the driver-applied steering-back action has been detected; and
a rollover prevention control section configured to execute rollover prevention control by controlling the actuator, when it is predicted for the predetermined level of roll motion to occur by the rollover prediction section and the rollover decision that rollover will occur has been made by the rollover decision section.

2. The vehicle rollover prevention control apparatus as claimed in claim 1, further comprising:
a steering angular velocity detector configured to detect a steering angular velocity during a driver-applied further steering action,
wherein the rollover prediction section is configured to execute the rollover prediction, when the steering angular velocity, detected by the steering angular velocity detector, is higher than or equal to a preset velocity.

3. The vehicle rollover prevention control apparatus as claimed in claim 2, wherein:
the rollover prediction section is further configured to start the rollover prediction after a predetermined elapsed time has expired from a starting point of the driver-applied steering input.

4. The vehicle rollover prevention control apparatus as claimed in claim 2, wherein:
the rollover decision section is further configured to cancel the rollover prediction, when there is no detection of the driver-applied steering-back action after a predetermined elapsed time has expired from a point of time when it has been predicted for the predetermined level of roll motion to occur by the rollover prediction section.

5. The vehicle rollover prevention control apparatus as claimed in claim 4, wherein:
the actuator comprises a brake system by which braking forces are applied to respective road wheels of the vehicle; and
the rollover prevention control section is further configured to apply the braking forces to front-left and front-right road wheels of the vehicle during the rollover prevention control.

6. The vehicle rollover prevention control apparatus as claimed in claim 5, further comprising:
a road-surface friction coefficient calculation section configured to calculate a road-surface friction coefficient of a road surface on which the vehicle is traveling,
wherein the rollover prevention control section is further configured to enable execution of the rollover prevention control when the road-surface friction coefficient, calculated by road-surface friction coefficient calculation section, is greater than or equal to a predetermined threshold value, and configured to disable execution of the rollover prevention control when the calculated road-surface friction coefficient is less than the predetermined threshold value.

7. The vehicle rollover prevention control apparatus as claimed in claim 1, further comprising:
variable damping force electronically-controlled suspensions, associated with respective road wheels of the vehicle,
wherein the rollover prevention control section is further configured to execute initial suspension rollover prevention control according to which compression-side damping forces of the electronically-controlled suspensions associated with the outside road wheels turning are varied to higher damping forces, when it is predicted for the predetermined level of roll motion to occur by the rollover prediction section.

8. The vehicle rollover prevention control apparatus as claimed in claim 1, further comprising:
a variable assistance force steering system configured to variably adjust a steering assistance force,
wherein the rollover prevention control section is further configured to execute initial steering rollover prevention control according to which the steering assistance force, acting in a further steering direction, is reduced from its current value, when it is predicted for the predetermined level of roll motion to occur by the rollover prediction section.

9. A vehicle rollover prevention control apparatus comprising:
an actuator configured to control a dynamic behavior of a vehicle;
a steering angular velocity detection section configured to detect a steering angular velocity during a driver-applied further steering action;
a steering angle sensor configured to detect a steering angle;
a yaw rate sensor configured to detect a yaw rate of the vehicle;
an acceleration sensor configured to detect a lateral acceleration exerted on the vehicle;
a rollover prediction section configured to make a prediction, based on at least a signal from the steering angular velocity detection section and a signal from the steering angle sensor, whether a predetermined level of roll motion for the vehicle occurs;
a vehicle behavior detection section configured to detect the vehicle dynamic behavior based on information from at least the yaw rate sensor and the acceleration sensor;
a rollover decision section configured to make a rollover decision about rollover of the vehicle when a driver-applied steering-back action has been detected for a period of time during which the vehicle behavior detection section determines that a specified vehicle behavior occurs; and
a rollover prevention control section configured to execute rollover prevention control by controlling the actuator, when the rollover decision that rollover will occur has been made by the rollover decision section.

10. The vehicle rollover prevention control apparatus as claimed in claim 9, wherein:
the rollover prediction section is further configured to start the rollover prediction after a predetermined elapsed time has expired from a starting point of the driver-applied steering input.

11. The vehicle rollover prevention control apparatus as claimed in claim 9, wherein:
the rollover decision section is further configured to cancel the rollover prediction, when there is no detection of the driver-applied steering-back action after a predetermined elapsed time has expired from a point of time when it has been predicted for the predetermined level of roll motion to occur by the rollover prediction section.

12. The vehicle rollover prevention control apparatus as claimed in claim 9, wherein:
the actuator comprises a brake system by which braking forces are applied to respective road wheels of the vehicle; and
the rollover prevention control section is further configured to apply the braking forces to front-left and front-right road wheels of the vehicle during the rollover prevention control.

13. The vehicle rollover prevention control apparatus as claimed in claim 9, further comprising:
a road-surface friction coefficient calculation section configured to calculate a road-surface friction coefficient of a road surface on which the vehicle is traveling,
wherein the rollover prevention control section is further configured to enable execution of the rollover prevention control when the road-surface friction coefficient, calculated by road-surface friction coefficient calculation section, is greater than or equal to a predetermined threshold value, and configured to disable execution of the rollover prevention control when the calculated road-surface friction coefficient is less than the predetermined threshold value.

14. The vehicle rollover prevention control apparatus as claimed in claim 12, further comprising:
variable damping force electronically-controlled suspensions, associated with respective road wheels of the vehicle,
wherein the rollover prevention control section is further configured to execute initial suspension rollover prevention control according to which compression-side damping forces of the electronically-controlled suspensions associated with the outside road wheels turning are varied to higher damping forces, when it is predicted for the predetermined level of roll motion to occur by the rollover prediction section.

15. The vehicle rollover prevention control apparatus as claimed in claim 12, further comprising:
a variable assistance force steering system configured to variably adjust a steering assistance force,
wherein the rollover prevention control section is further configured to execute initial steering rollover prevention control according to which the steering assistance force, acting in a further steering direction, is reduced from its current value, when it is predicted for the predetermined level of roll motion to occur by the rollover prediction section.

16. The vehicle rollover prevention control apparatus as claimed in claim 12, further comprising:
variable damping force electronically-controlled suspensions, associated with respective road wheels of the vehicle; and
a variable assistance force steering system configured to variably adjust a steering assistance force,
wherein the rollover prevention control section is further configured to execute initial suspension rollover prevention control according to which compression-side damping forces of the electronically-controlled suspensions associated with the outside road wheels turning are varied to higher damping forces, and simultaneously to execute initial steering rollover prevention control according to which the steering assistance force, acting in a further steering direction, is reduced from its current value, when it is predicted for the predetermined level of roll motion to occur by the rollover prediction section.

17. A vehicle rollover prevention control method comprising:
executing a rollover prediction, based on a steering angular velocity of a vehicle during a driver-applied further steering action, whether a high level of roll motion for the vehicle occurs; and
executing rollover prevention control when a driver-applied steering-back action has been detected after the rollover prediction has been satisfied.

18. The vehicle rollover prevention control method as claimed in claim 17, wherein:
the rollover prevention control is executed by applying braking forces to front-left and front-right road wheels of the vehicle.

19. The vehicle rollover prevention control method as claimed in claim 18, further comprising:
canceling the rollover prediction, when there is no detection of the driver-applied steering-back action after a predetermined elapsed time has expired from a point of time when it has been predicted for the high level of roll motion to occur.

20. The vehicle rollover prevention control method as claimed in claim 18, further comprising:
executing at least one of suspension control for variable damping force electronically-controlled suspensions, associated with respective road wheels of the vehicle, and steering control for a variable assistance force steering system, after the rollover prediction has been satisfied and before the rollover prevention control.
